(19) United States
(12) Patent Application Publication
(10) Pub. No.: US 2024/0121176 A1
(43) Pub. Date: Apr. 11, 2024

(54) BAND CALCULATION DEVICE, BAND CALCULATION METHOD, AND PROGRAM

(71) Applicant: NIPPON TELEGRAPH AND TELEPHONE CORPORATION, Tokyo (JP)

(72) Inventors: Erina TAKESHITA, Tokyo (JP); Tomoya KOSUGI, Tokyo (JP); Yuki YAMADA, Tokyo (JP)

(73) Assignee: NIPPON TELEGRAPH AND TELEPHONE CORPORATION, Tokyo (JP)

(21) Appl. No.: 18/276,634

(22) PCT Filed: Feb. 12, 2021
(86) PCT No.: PCT/JP2021/005308

§ 371 Date: Aug. 9, 2023

(51) Int. Cl. H04L 45/00; H04L 45/02; H04L 45/28

(52) U.S. Cl. CPC H04L 45/22; H04L 45/02; H04L 45/28

(57) ABSTRACT

A band calculation device (1) according to the present disclosure, in the band calculation device (1) which calculates a band of the link (L) of a relay network (NWR) which is constituted by nodes (N) and links (L) and which relays information transmitted and received between a plurality of communication bases, includes an input unit (21) that receives an input of topology information indicating ports (P) of nodes (N), connection destination ports of the ports (P), and links, respectively, path information indicating primary paths that relay the information when a failure does not occur, paths including backup paths that relay the information when the failure occurs in the primary path, and via transmission ports that are the ports (P) for transmitting the information in the paths, respectively, and traffic information indicating the port (P) and traffic statistic value of the port (P), respectively, and a calculation unit (22) that calculates a band of the link (L) on the basis of the topology information, the path information and the traffic information.

### TECHNICAL FIELD

The present disclosure relates to a band calculation device, a band calculation method, and a program.

### BACKGROUND ART

Conventionally, there has been known a technique for calculating a band required when a failure occurs in a network in consideration of a bypass path. For example, a technique for determining a bypass path through which information is transmitted when a failure occurs in accordance with traffic volume is described in NPL 1. PTL 1 describes calculating a target communication band based on observation data indicating a time-series change in the traffic volume of each existing line observed through a target communication path by using the technique described in NPL 1.

### CITATION LIST

### Patent Literature

[PTL 1] Japanese Patent Application Laid-open No. 2009-118274

### Non Patent Literature

[NPL 1] Hiroki Furuya, six others, “An Optimal Route Computation Method for GMPLS Survivable Network with a Tabu Search Algorithm for the Weighted Constraint Satisfaction Problem”, Networks 2006

### SUMMARY OF INVENTION

### Technical Problem

However, as the size of the relay network becomes large, the path and topology become complicated. In addition, the path and topology may be changed in accordance with the change of the facility in accordance with the change of the utilization status of the relay network. In such a situation, in view of the traffic volume when a failure occurs, there is a tendency that man-hours required for calculating the communication band of the link constituting the relay network for each topology is increased.

An object of the present disclosure, which has been made in view of the above-described problems, is to provide a band calculation device, a band calculation method, and a program that can reduce man-hours required for processing of calculating a band of a link constituting a relay network.

### Solution to Problem

In order to solve the above problem, a band calculation device according to the present disclosure, which calculates a band of the link of a relay network which is constituted by nodes and links connecting the nodes and which relays information transmitted and received between a plurality of communication bases, includes an input unit that receives an input of topology information indicating ports of nodes constituting the relay network, connection destination ports of the ports, and links connecting the ports and the connection destination ports, respectively, path information indicating primary paths that relay the information when a failure does not occur, paths including backup paths that relay the information when the failure occurs in the primary path, and via transmission ports that are the ports for transmitting the information in the paths, respectively, and traffic information indicating the port and traffic statistic value of the port, respectively, and a calculation unit that calculates a band of the link on the basis of the topology information, the path information and the traffic information.

In addition, in order to solve the above problem, a band calculation method according to the present disclosure, which calculates a band of the link of a relay network which is constituted by nodes and links connecting the nodes and which relays information transmitted and received between a plurality of communication bases, includes a step of receiving an input of topology information indicating ports of nodes constituting the relay network, connection destination ports of the ports, and links connecting the ports and the connection destination ports, respectively, path information indicating primary paths that relay the information when a failure does not occur, paths including backup paths that relay the information when the failure occurs in the primary path, and via transmission ports that are the ports for transmitting the information in the paths, respectively, and traffic information indicating the port and traffic statistic value of the port, respectively, and a step of calculating a band of the link on the basis of the topology information, the path information and the traffic information.

Further, in order to solve the above problem, a program according to the present disclosure causes a computer to function as the band calculation device described above.

### Advantageous Effects of Invention

According to a display method, a band calculation device, and a program according to the present disclosure, man-hours required for processing of calculating a band of a link constituting a relay network can be reduced.

### BRIEF DESCRIPTION OF DRAWINGS

FIG. 1 is a diagram showing an overall outline of a band calculation system according to a first embodiment.

FIG. 2 is a diagram showing a first example of a relay network in which the band calculation device shown in FIG. 1 calculates a band.

FIG. 3 is a diagram showing a first example of topology information stored in a topology storage unit shown in FIG. 1.

FIG. 4 is a diagram showing a first example of path information stored in a path storage unit shown in FIG. 1.

FIG. 5 is a diagram showing a first example of traffic information stored in a traffic statistic storage unit shown in FIG. 1.

FIG. 6 is a diagram showing a first example of primary bands calculated by a calculation unit shown in FIG. 1.

FIG. 7 is a diagram showing a first example of backup bands calculated by the calculation unit shown in FIG. 1.

FIG. 8 is a diagram showing a first example of band candidates calculated by the calculation unit shown in FIG. 1.

FIG. 9 is a diagram showing a first example of bands of each node calculated by the calculation unit shown in FIG. 1.

FIG. 10 is a diagram showing a second example of a relay network in which the band calculation device shown in FIG. 1 calculates a band.

FIG. 11 is a diagram showing a second example of topology information stored in the topology storage unit shown in FIG. 1.

FIG. 12 is a diagram showing a second example of path information stored in the path storage unit shown in FIG. 1.

FIG. 13 is a diagram showing a second example of traffic information stored in the traffic statistic storage unit shown in FIG. 1.

FIG. 14 is a diagram showing a second example of primary bands calculated by the calculation unit shown in FIG. 1.

FIG. 15 is a diagram showing a second example of backup bands calculated by the calculation unit shown in FIG. 1.

FIG. 16 is a diagram showing a second example of band candidates calculated by the calculation unit shown in FIG. 1.

FIG. 17 is a diagram showing a second example of bands of each node calculated by the calculation unit shown in FIG. 1.

FIG. 18 is a flow chart showing an example of an operation of the band calculation device shown in FIG. 1.

FIG. 19 is a diagram showing a modification example of the first example of the backup bands calculated by the calculation unit shown in FIG. 1.

FIG. 20 is an example of the band candidates calculated by the calculation unit shown in FIG. 1.

FIG. 21 is an example of the bands calculated by the calculation unit shown in FIG. 1.

FIG. 22 is an overall outline of a band calculation system according to a second embodiment.

FIG. 23 is a diagram showing an example of a relay network in which the band calculation device shown in FIG. 22 calculates a band.

FIG. 24 is a diagram showing an example of path information in communication between a first communication base and a second communication base stored in a path storage unit shown in FIG. 22.

FIG. 25 is a diagram showing an example of path information in communication between the second communication base and a third communication base stored in the path storage unit shown in FIG. 22.

FIG. 26 is a diagram showing an example of path information in communication between the third communication base and the first communication base stored in the path storage unit shown in FIG. 22.

FIG. 27 is a diagram showing an example of primary bands in communication between the first communication base and the second communication base calculated by a calculation unit shown in FIG. 22.

FIG. 28 is a diagram showing an example of backup bands in communication between the first communication base and the second communication base by the calculation unit shown in

FIG. 22.

FIG. 29 is a diagram showing an example of band candidates in communication between the first communication base and the second communication base calculated by the calculation unit shown in FIG. 22.

FIG. 30 is a diagram showing an example of a primary band in communication between the second communication base and the third communication base calculated by the calculation unit shown in FIG. 22.

FIG. 31 is an example of backup bands in communication between the second communication base and the third communication base by the calculation unit shown in FIG. 22.

FIG. 32 is a diagram showing an example of band candidates in communication between the second communication base and the third communication base calculated by the calculation unit shown in FIG. 22.

FIG. 33 is an example of primary bands in communication between the third communication base and the first communication base calculated by the calculation unit shown in FIG. 22.

FIG. 34 is a diagram showing an example of backup bands in communication between the third communication base and the first communication base by the calculation unit shown in FIG. 22.

FIG. 35 is a diagram showing an example of band candidates in communication between the third communication base and the first communication base calculated by the calculation unit shown in FIG. 22.

FIG. 36 is a diagram showing an example of total band candidates of the relay network calculated by the calculation unit shown in FIG. 22.

FIG. 37 is a diagram showing an example of bands of the relay network calculated by the calculation unit shown in FIG. 22.

FIG. 38 is a flow chart showing an example of an operation of the band calculation device shown in FIG. 22.

FIG. 39 is a diagram showing an overall outline of a band calculation system according to a third embodiment.

FIG. 40 is a diagram showing an example of a relay network in which the band calculation device shown in FIG. 39 calculates a band.

FIG. 41 is a diagram showing a redundant configuration divided by a division unit shown in FIG. 39.

FIG. 42 is a flow chart showing an example of an operation of the band calculation device shown in FIG. 39.

FIG. 43 is a flow chart for describing a part of the flow chart shown in FIG. 42 in detail.

FIG. 44 is a hardware block diagram of the band calculation devices according to the first to third embodiments.

### DESCRIPTION OF EMBODIMENTS

First, embodiments of the present disclosure will be described with reference to the drawings.

### First Embodiment

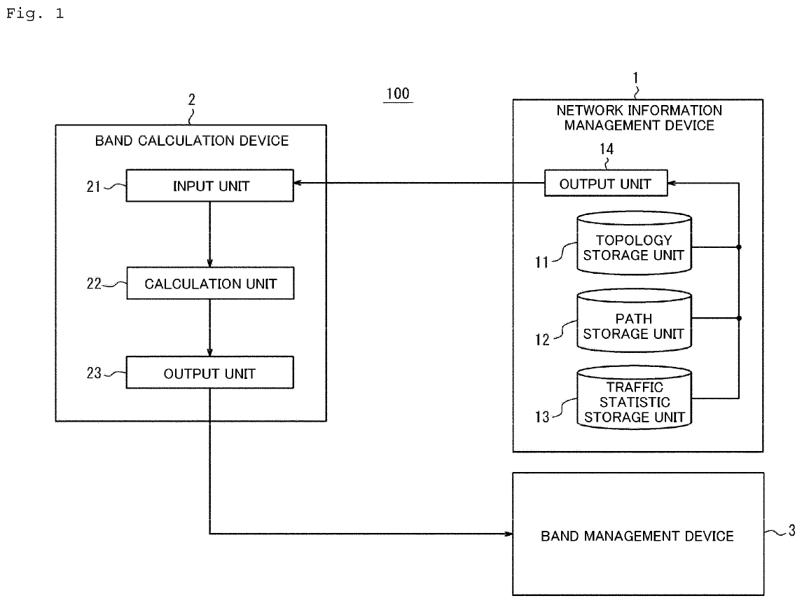

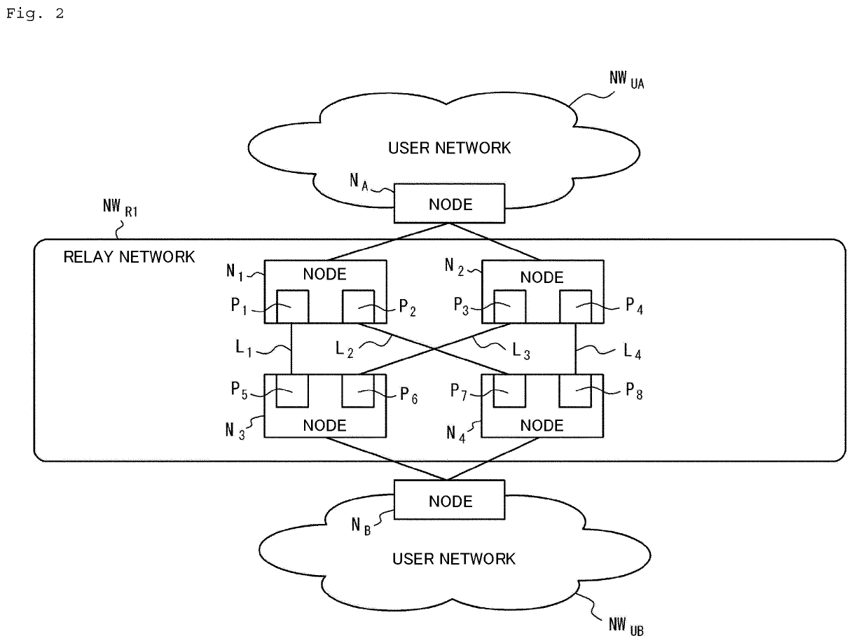

The overall configuration of a first embodiment will be described with reference to FIG. 1. FIG. 1 is a schematic diagram of a band calculation system 100 according to a first embodiment.

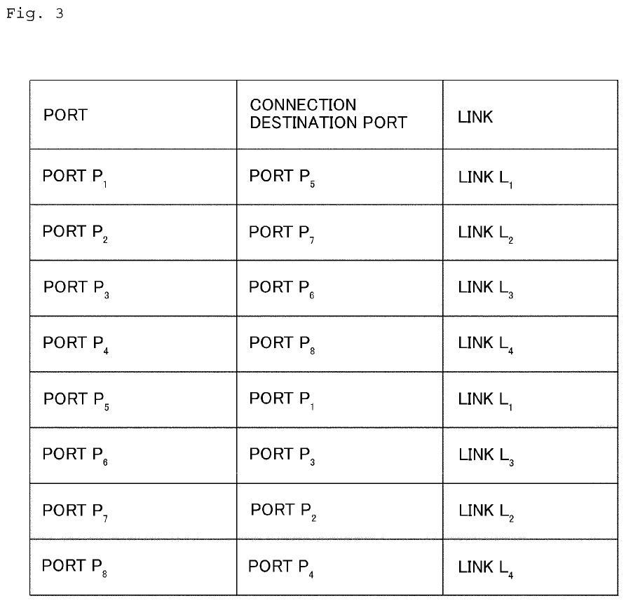

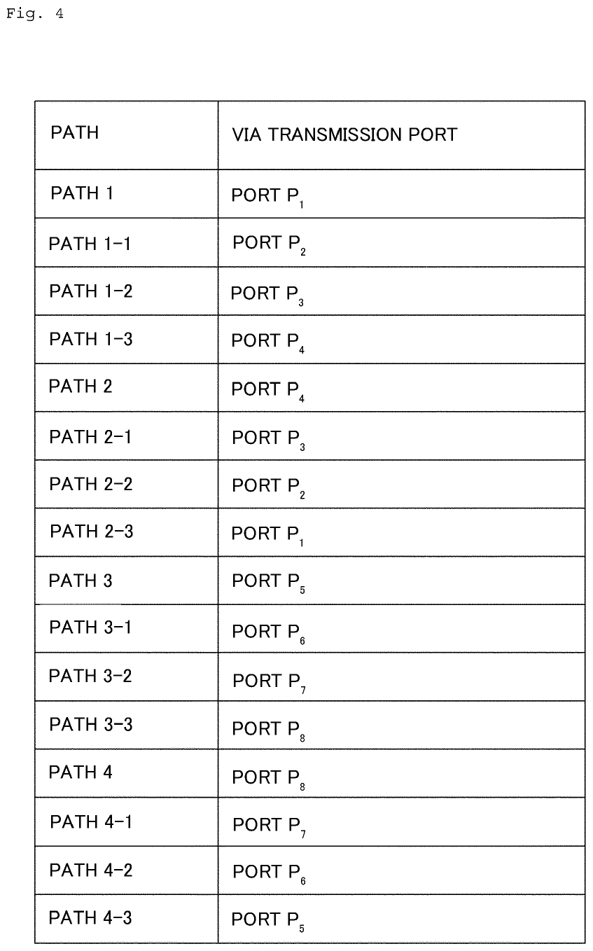

The band calculation system 100 according to the first embodiment calculates a band of a relay network NW_{R1} which relays information transmitted and received between nodes N_{A} and N_{B} included in two user networks NW_{UA} and NW_{UB}, respectively, as shown in FIG. 2. The band calculation system 100 includes a network information management device 1, a band calculation device 2, and a band management device 3.

Thereafter, when the user networks NW_{UA} and NW_{UB} and the user networks NW_{UC} and NW_{UD} described later are not distinguished from each other, they are simply referred to as “user network NM_{U}”. Further, nodes N_{A} and N_{B} included in the user network NW_{U} directly connected from a node included in the relay network NW_{R1} (not via other devices) may be referred to as “communication bases”.

### <Functional Configuration of Network Information Management Device>

The network information management device 1 manages information on the relay network NW_{R1}. As described above, the relay network NW_{R1} relays information transmitted and received between the plurality of user networks NW_{U}. In addition, the relay network NW_{R1} is configured to transmit and receive information transmitted and received via a primary path via a backup path when a part of the communication path is disconnected due to an occurrence of a failure or the like of the relay network NW_{R1}, and to continue transmission and reception of the information between the plurality of user networks NW_{U}. Note that the primary path is a path through which information is relayed when no failure occurs, and the backup path is a path through which information is relayed when the failure occurs in the primary path. The path is a path through which information is transmitted between one user network NW_{U} (user network NW_{UA} in this example) and another user network NW_{U} (user network NW_{UB} in this example).

In this way, the relay network NW_{R1} is provided with a redundant path by the primary path and the backup path. Therefore, the topology of the relay network NW_{R1} can be a ring type, a mesh type, or the like. In addition, the primary path and the backup path in the relay network NW_{R1} are designed in advance, and the backup path switched from the primary path in response to disconnection of communication in the relay network NW_{R1} is determined in advance.

The network topology of the relay network NW_{R1} in the example shown in FIG. 2 is a mesh type. The relay network NW_{R1} of this example is provided with four nodes N from a node N₁ to a node N₄, and the nodes Nₖ (k=1 to 4) have two ports P for communicating with other nodes, respectively. In this example, a node N₁ has a port P₁ and a port P₂, a node N₂ has a port P₃ and a port P₄, a node N₃ has a port P₅ and a port P₆, and a node N₄ has a port P₇ and a port P₈. Thereafter, when the nodes N₁ to N₄ are not distinguished from each other, the nodes N₁ to N₄ are simply referred to as “node N”. In addition, when the ports P₁ to P₈ are not distinguished from each other, it is simply called “port P”. Further, when the links L₁ to L₄ are not distinguished from each other, it is simply called “link L”. This is not limited to this example, but the same is also applied to other examples.

The port P of one node N and the port P of the other node N are connected by a link L. In this example, the port P₁ and the port P₅ are connected by a link L₁, the port P₂ and the port P₇ are connected by a link L₂, the port P₃ and the port P₆ are connected by a link L₃, and the port P₄ and the port P₈ are connected by a link L₄.

As shown in FIG. 1, the network information management device 1 includes a topology storage unit 11, a path storage unit 12, a traffic statistic storage unit 13, and an output unit 14. The topology storage unit 11, the path storage unit 12, and the traffic statistic storage unit 13 are constituted by, for example, a ROM (Read only Memory) or a storage. The output unit 14 is an interface for outputting information to other equipment such as external devices, and standards such as Ethernet (registered trademark), FDDI (Fiber Distributed Data Interface), and Wi-Fi (registered trademark) are used, for example.

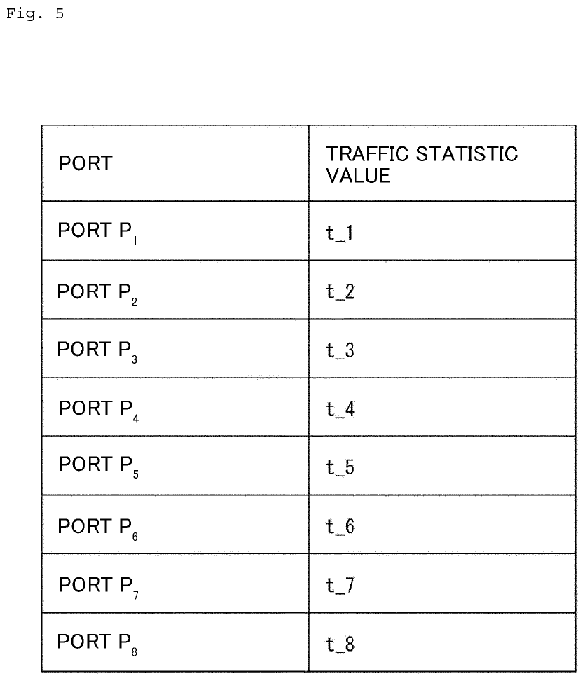

The topology storage unit 11 stores topology information indicating a port P of a node N, a connection destination port of the port P, and a link L connecting the port P and the connection destination port constituting the relay network NW_{R}, as shown in FIG. 3. Such topology information indicates how devices in the relay network are connected. In this example, the topology of the relay network NW_{R1} is a mesh type and corresponds to FIG. 2. The connection destination port is a connection destination port P to which each of the ports P is connected. The link L is a communication line for connecting the port P and the connection destination port of the port P.

The path storage unit 12 also stores path information. The path information indicates the primary path to which information is relayed when no failure occurs, the backup path to which information is relayed instead of the primary path when the failure occurs in the primary path, and a via transmission port which is a port P to transmit information in each of the primary path and the backup path. The path information indicates via which port information is transmitted in the primary path and the backup path, respectively.

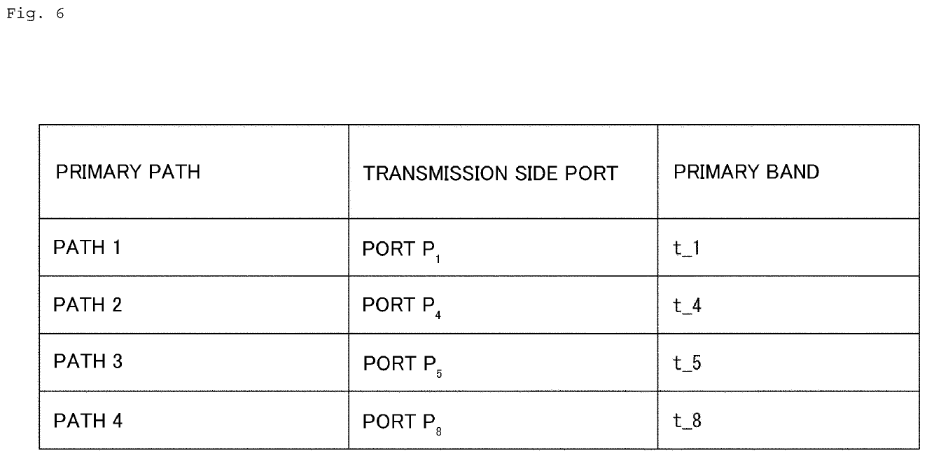

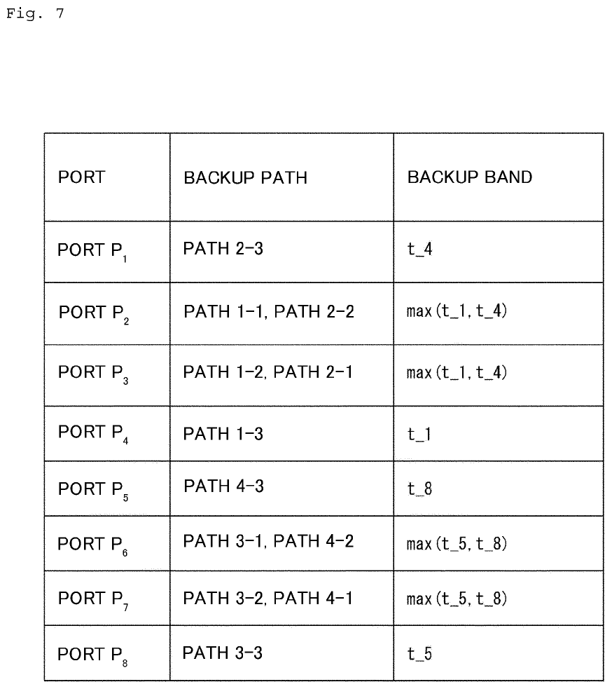

In an example shown in FIG. 4, the primary path is indicated as “path i” (i is an integer), and the backup path is indicated as “path i-j” (j is an integer). The backup path identified by the “path i-j” is a path through which information is transmitted when the failure occurs in the “path i”. For example, when a failure occurs in a path identified by “path 1”, information is transmitted by any of paths identified by “path 1-1”, “path 1-2”, and “path 1-3”. In addition, when a fault occurs in the path identified by the “path 2”, information is transmitted by any of the paths identified by “path 2-1”, “path 2-2”, and “path 2-3”. This applies “path 3” and “path 4”.

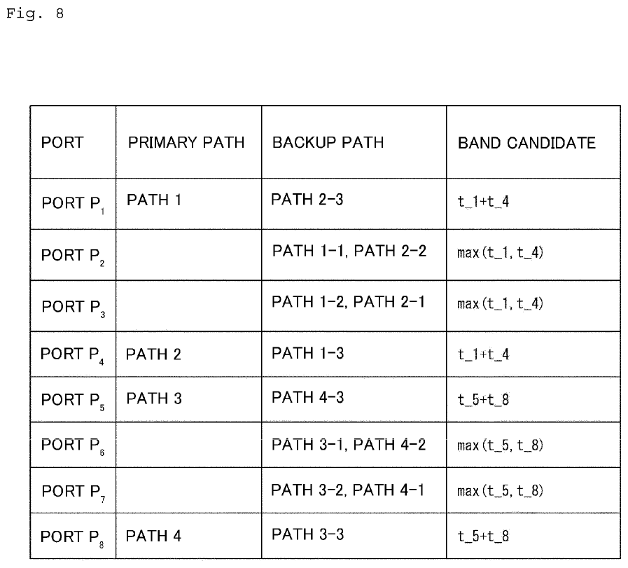

The traffic statistic storage unit 13 stores traffic information indicating the port P and traffic statistic value of the port P, as shown in FIG. 5. The traffic statistic value is a statistic value of a traffic volume of information transmitted by the port P. The statistic value may be, for example, an average value, a median value, a maximum value, or the like of the traffic volume in a predetermined period.

The output unit 23 outputs the topology information, the path information, and the traffic information stored in the topology storage unit 11, the path storage unit 12, and the traffic statistic storage unit 13, respectively, to the band calculation device 2.

### <Functional Configuration of Band Calculation Device>

The band calculation device 2 calculates a band of a link L of the relay network NW_{R1} which is constituted by the node N and the link L connecting ports P of the node N and which relays information transmitted and received between a plurality of communication bases.

As shown in FIG. 1, the band calculation device 2 includes an input unit 21, a calculation unit 22, and an output unit 23. The input unit 21 is constituted by the input interface for receiving the input of information. The input interface can be an interface for receiving information received from another device via a communication network. The calculation unit 22 constitutes a control unit (controller). The control unit may be constituted by dedicated hardware such as an application specific integrated circuit (ASIC) or a field-programmable gate array (FPGA), may be constituted by a processor, or may be constituted by including both. Hereinafter, details of each functional unit will be described together with processing using the first example in which each functional unit corresponds to topology information, path information, and traffic information shown in FIGS. 3 to 5.

The input unit 21 receives, from the network information management device 1, an input of the topology information, the path information and the traffic information stored in the topology storage unit 11, the path storage unit 12, and the traffic statistic storage unit 13, respectively.

The calculation unit 22 calculates the band of the link L on the basis of the topology information, the path information, and the traffic information whose input is received by the input unit 21. Specifically, the calculation unit 22 calculates the primary band which is a traffic volume of information transmitted by a transmission side port of the primary path when no failure occurs on the basis of the path information and the traffic information. Then, when the failure occurs, the calculation unit 22 calculates the backup band that is a traffic volume of information transmitted by the via transmission port of the backup path having the transmission side port of the primary path as the via transmission port, and calculates the band of the link L on the basis of the topology information, the primary band and the backup band. The transmission side port is a port P for transmitting information in the node N when the information is relayed via a path including the primary path and the backup path. When information is relayed via a path including the primary path and the backup path, the via transmission port is a port closest to a communication base for transmitting the information on the path.

The detail of processing performed by the calculation unit 22 will be described below.

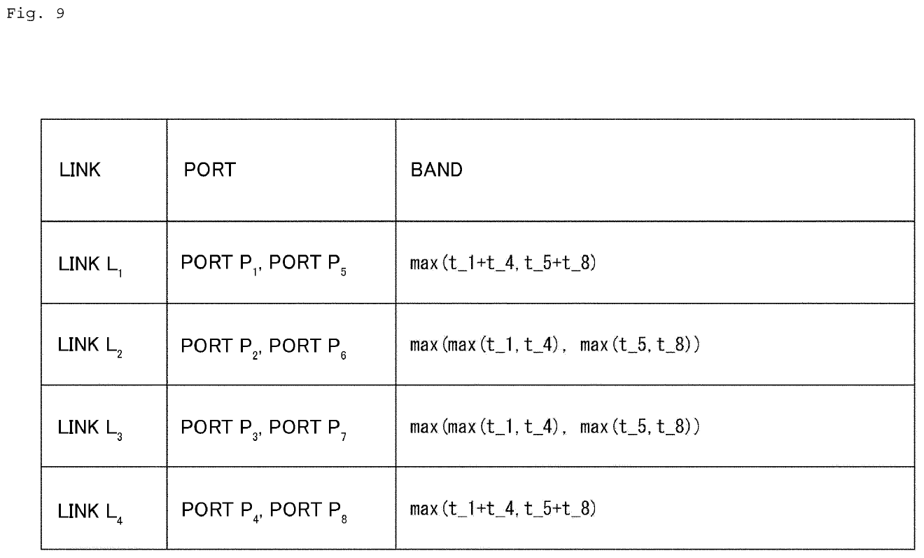

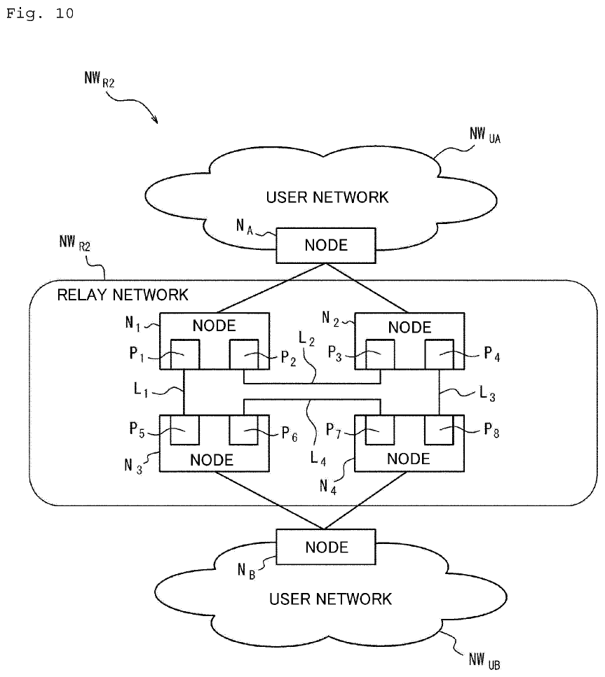

First, the calculation unit 22 extracts a transmission side port from a via transmission port of the primary path from path information. The calculation unit 22 extracts a port P₁ which is a transmission side port of the primary path “path 1” from the path information shown in FIG. 4 (refer to FIG. 6). Similarly, the calculation unit 22 extracts transmission side ports of the “path 2” to “path 4” which are primary paths from the path information (refer to FIG. 6).

The calculation unit 22 calculates the primary band of the transmission side port of the primary path as a traffic statistic value of a via transmission port of the primary path on the basis of the traffic information. The primary band is a traffic volume of information expected to be transmitted by the transmission side port of the primary path when no failure occurs in the primary path. As described using example of FIGS. 3 to 6, the calculation unit 22 calculates the primary band of the port P₁ which is the transmission side port of the primary path “path 1” as “t_1” which is a traffic statistic value corresponding to the port P₁ in the traffic information shown in FIG. 5 (refer to FIG. 6). Similarly, the calculation unit 22 calculates the primary bands of the transmission side ports of the “path 2”, “path 3” and “path 4” which are primary paths.

In addition, the calculation unit 22 calculates the backup band of the port P on the basis of the path information and the traffic information. The backup band is a traffic volume of information expected to be transmitted by the port P when the failure occurs in the primary path. Specifically, the calculation unit 22 calculates the backup band of the port P as the primary band of the primary path corresponding to the backup path having the transmission side port of the primary path as the via transmission port on the basis of the path information. When a plurality of backup paths having the transmission side port of the primary path as the via transmission port are indicated in the path information, the calculation unit 22 calculates the backup band of the port P as a maximum value of the primary band of the primary path corresponding to each of the plurality of backup paths.

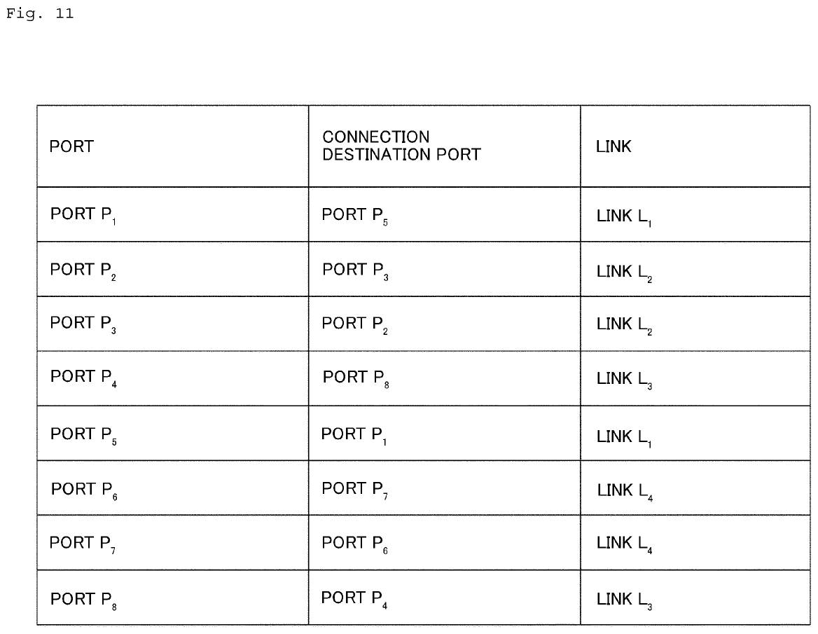

As described using example of FIGS. 3 to 6, the calculation unit 22 extracts a primary path “path 2” corresponding to a backup path “path 2-3” using a port P₁ as a via transmission port on the basis of path information shown in FIG. 4. Then, the calculation unit 22 calculates the backup band of the port P₁ as the primary band “t_4” of the extracted primary path “path 2” (refer to FIG. 7).

In addition, the calculation unit 22 extracts “path 1” and “path 2” which are primary paths corresponding to backup paths “path 1-1” and “path 2-2” using the port P₂ as the via transmission port on the basis of path information shown in FIG. 4. Then, the calculation unit 22 calculates the backup band of the port P₂ as the maximum value “max (t_1, t_4)” among the primary bands “t_1” and “t_4” of the extracted “path 1” and “path 2” (refer to FIG. 7). Similarly, the calculation unit 22 calculates the backup bands of each port of P₃ to P₈

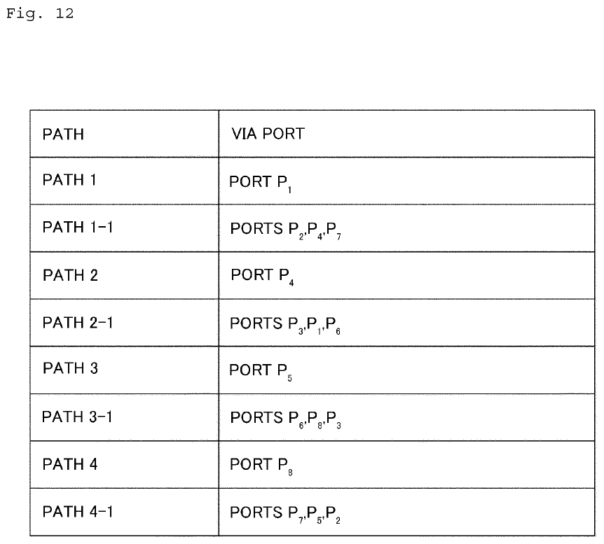

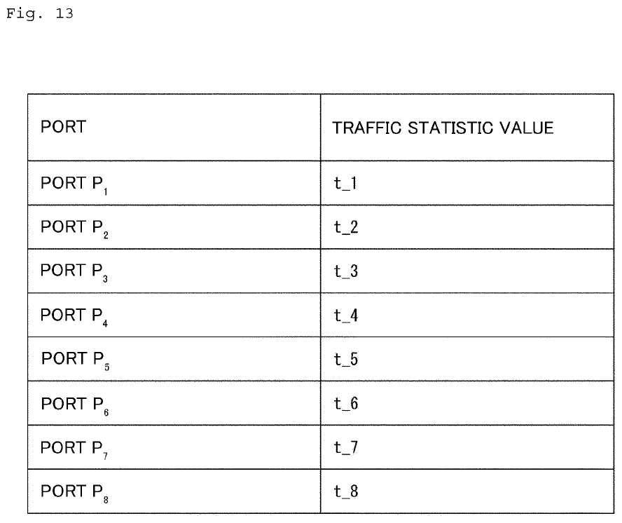

The calculation unit 22 calculates a band candidate of the port P on the basis of the primary band and the backup band of the port P. Specifically, the calculation unit 22 calculates the band candidate of the port P as the sum of the primary band and the backup band of the port. As described using example of FIGS. 3 to 7, the calculation unit 22 calculates the band candidates of the port P₁ as the sum “t_1+t_4” of the primary band “t_1” of the port P₁ shown in FIG. 6 and the backup band “t_4” shown in FIG. 7 (refer to FIG. 8). In addition, since any primary path does not pass through the port P₂, the primary band of the port P₂ is “0”. Therefore, the calculation unit 22 calculates the band candidate of the port P₂ as the sum “max (t_1, t_4)” of the primary band “0” and the backup bands “max (t_1, t_4)” of the port P₂ (refer to FIG. 8). In the same way, the calculation unit 22 calculates band candidates for each of the ports of P₃ to P₈.

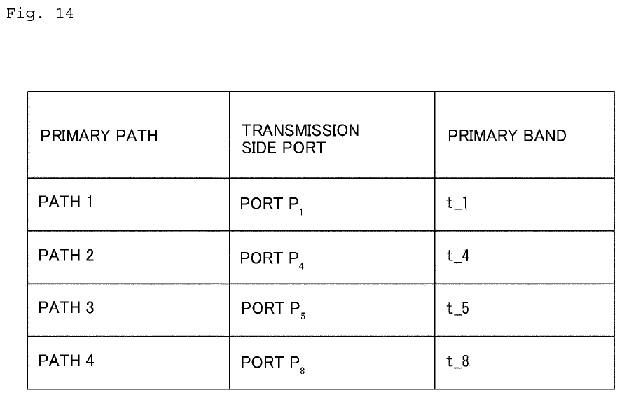

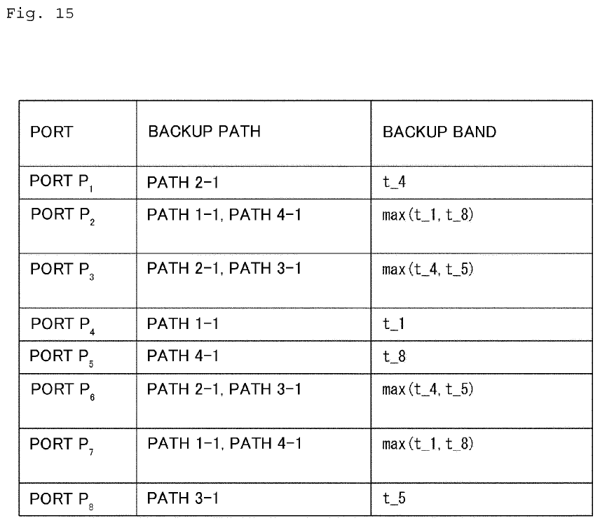

The calculation unit 22 calculates the band of the link L on the basis of the band candidate of the port P and the topology information. Specifically, the calculation unit 22 extracts two ports P to be connected to each other by each of the links L on the basis of the topology information, and sets the band of link L having larger band among the band candidates of the two ports P to the band candidate. As described using example of FIGS. 3 to 8, the link L₁ connects the port P₁ and the port P₅ to each other as shown in the topology information of FIG. 3. Here, the calculation unit 22 extracts the port P₁ and the port P₅ corresponding to the link L₁ (refer to FIG. 9). Then, the calculation unit 22 calculates the band of the link L₁ as a larger band candidate “max ((t_1+t_4), (t_5+t_8)) among the band candidate “t_1+t_4” of the port P₁ and the band candidate “t_5+t_8” of the port P5. Similarly, the calculation unit 22 calculates bands of links L₂ to L₄ (refer to FIG. 9).

The output unit 23 transmits band information indicating each band of the link L calculated by the calculation unit 22 to the band management device 3.

### Description for Other Examples

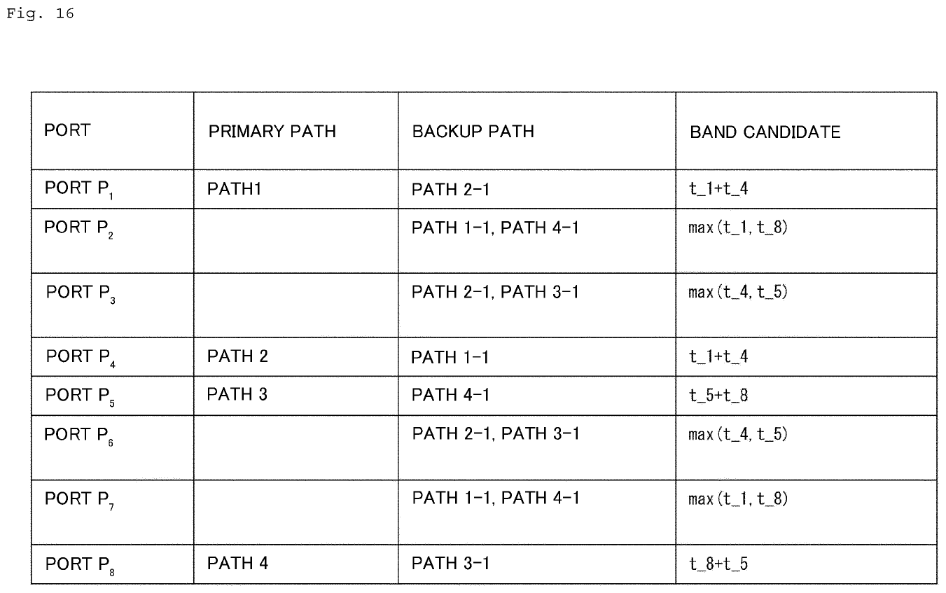

Here, the processing performed by the calculation unit 22 in the case where the topology information and the path information are a second example different from the first example will be described. As shown in FIG. 10, the relay network NW_{R2} constituted by the topology indicated by the topology information in the second example is a ring type.

In the second example, as shown in FIG. 10, nodes included in the two user networks NWA and NW_{UB} respectively communicate with each other via the relay network NW_{R2}. In this example, the network topology of the relay network NW_{R2} is a ring type. The relay network NW_{R2} of this example is provided with four nodes from a node N₁ to a node N₄, and the nodes Nₖ (k=1 to 4) have two ports P, respectively. In addition, in this example, the port P₁ and the port P₅ are connected by a link L₁, the port P₂ and the port P₃ are connected by a link L₂, the port P₄ and the port P₈ are connected by a link L₃, and the port P₆ and the port P₇ are connected by a link L₄.

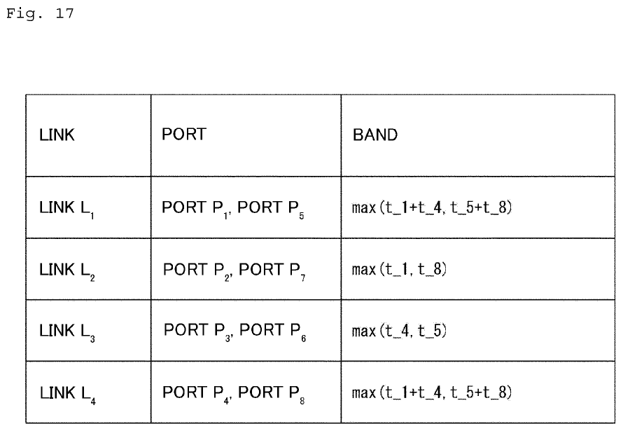

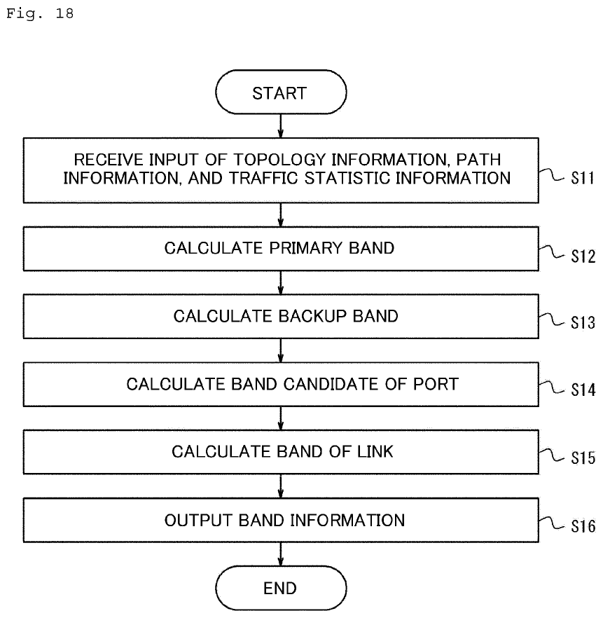

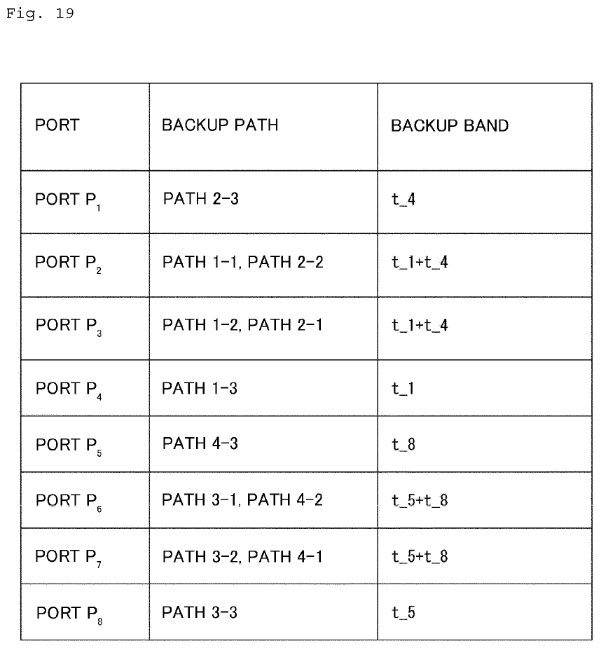

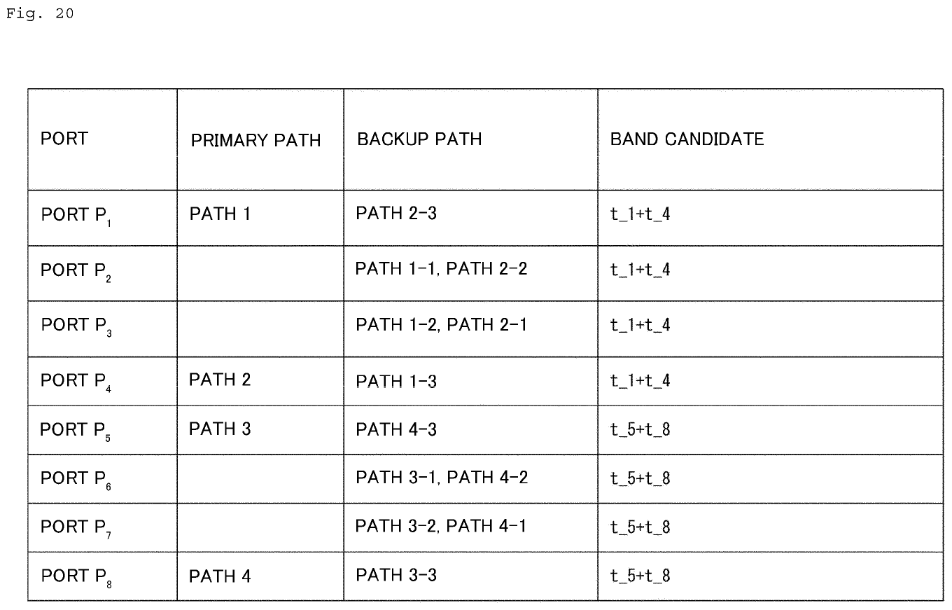

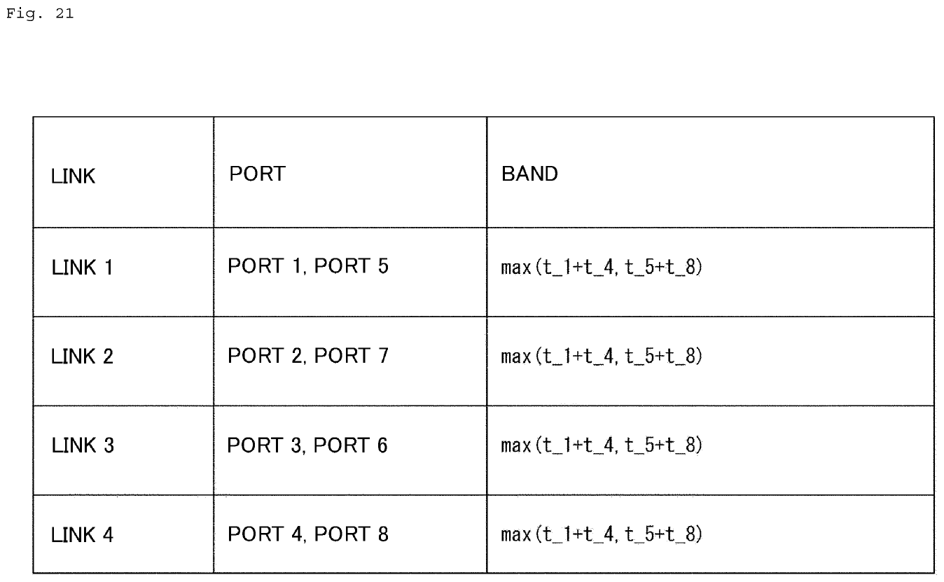

In the present example, the topology information indicates, as shown in FIG. 11, a port P, a connection destination port, and a link L in the relay network NW_{R2}. The path information indicates, as shown in FIG. 12, a path that is a transmission path when information is transmitted between one user network NW_{U} (in this example, user network NW_{UA}) and another user network NW_{U} (in this example, user network NW_{UB}) in the relay network NW_{R2}. In addition, as shown in FIG. 13, the traffic information indicates the port and the traffic statistic value of the port, respectively.

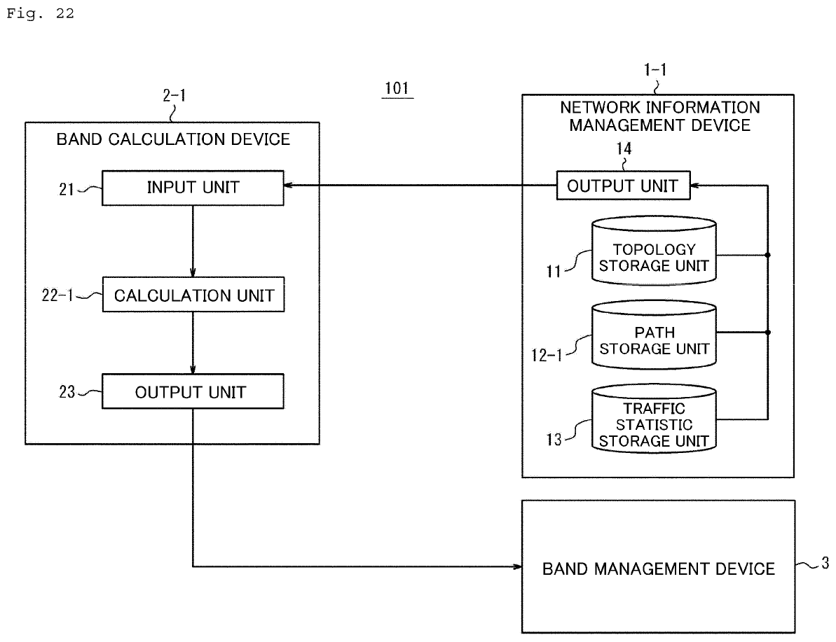

In this example, the calculation unit 22 extracts a port P₁ which is a transmission side port of a primary path “path 1” from path information shown in FIG. 12 (refer to FIG. 14). Similarly, the calculation unit 22 extracts transmission side ports of the primary paths “path 2” to “path 4”.

Then, the calculation unit 22 calculates a primary band of the port P₁ which is the transmission side port of the primary path “path 1” as “t_1” corresponding to the port P₁ in the traffic information shown in FIG. 13 (refer to FIG. 14). In the same way, the calculation unit 22 calculates the primary band of each transmission side port of “path 2” to “path 4” which are primary paths.

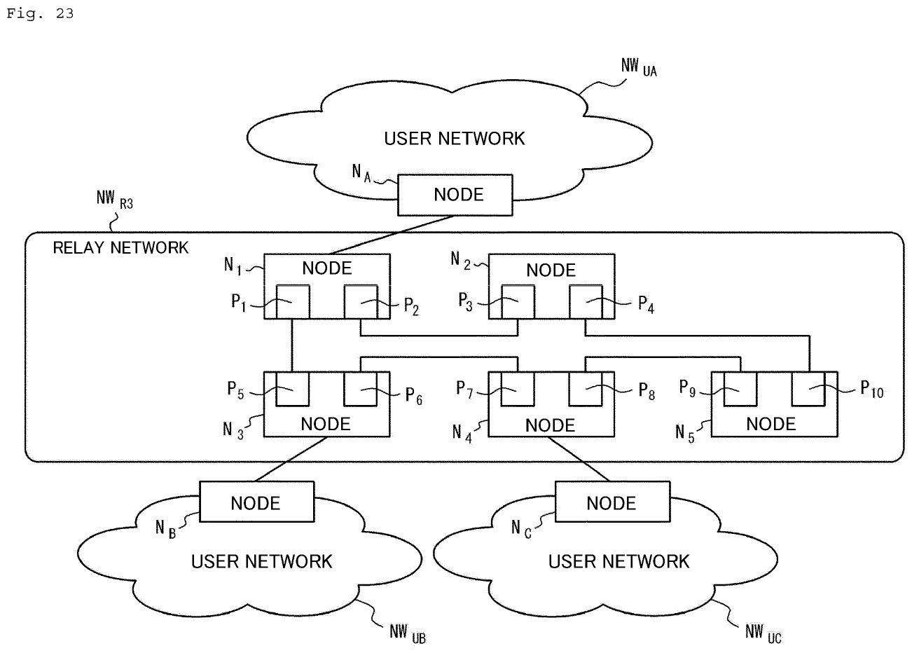

Then, the calculation unit 22 extracts a primary path “path 2” corresponding to a backup path “path 2-1” using the port P₁ as a via transmission port on the basis of path information shown in FIG. 12. Then, the calculation unit 22 calculates the backup band of the port P₁ as the primary band “t_4” of the extracted primary path “path 2” (refer to FIG. 15).

In addition, the calculation unit 22 extracts a primary path “path 1” and a primary path “path 4” corresponding to a backup path “path 1-1” and “path 4-1” using a port P₂ as a via transmission port on the basis of path information shown in FIG. 12. Then, the calculation unit 22 calculates the backup band of the port P₂ as the maximum value max (t_1, t_8) of the primary bands “t_1” and “t_8” of the extracted primary paths “path 1” and “path 4” (refer to FIG. 15). Similarly, the calculation unit 22 calculates the backup bands of the ports of P₃ to P₈.

Next, the calculation unit 22 calculates a band candidate of the port P₁ as the sum “t_1+t_4” of the primary band “t_1” of the port P₁ shown in FIG. 14 and the backup band “t_4” of the port P₁ shown in FIG. 15 (refer to FIG. 16). In addition, since any primary path does not pass through the port P₂, the primary band of the port P₂ is “0”. Therefore, the calculation unit 22 calculates the band candidate of the port P₂ as the sum “max (t_1, t_8)” of the primary band “0” and the backup band “max (t_1, t_8)” of the port P₂ (refer to FIG. 16). In the same way, the calculation unit 22 calculates band candidates for each of the ports of P₃ to P₈.

In a second example, as shown in the topology information of FIG. 11, the link L₁ connects the port P₁ and the port P₅ to each other. Here, a calculation unit 22 extracts the port P₁ and the port P₅ corresponding to the link L₁ (refer to FIG. 17). Then, the calculation unit 22 calculates a band of the link L₁ as a larger band candidate “max ((t_1+t_4), t_5+t_8)” of the band candidate “t_1+t_4” of the port P₁ and the band candidate “t_5+t_8” of the port P₅. Similarly, the calculation unit calculates bands of links L₂ to L₄ (refer to FIG. 9).

### <Operation of Band Calculation Device>

Here, the operation of the band calculation device 2 according to the first embodiment will be described with reference to FIG. 18. FIG. 18 is a flow chart showing an example of an operation of the band calculation device 2 according to the first embodiment. The operation of the band calculation device 2 which will be described with reference to FIG. 18 corresponds to a band calculation method of the band calculation device 2 according to the first embodiment.

In a step S11, the input unit 21 receives the topology information, the path information, and the traffic information from the network information management device 1.

In a step S12, the calculation unit 22 determines a primary band of a port P that is a transmission side port of a primary path on the basis of the path information and the traffic information.

In a step S13, the calculation unit 22 calculates a backup band of the port P on the basis of the path information and the traffic information.

In a step S14, the calculation unit 22 calculates a band candidate of the port P on the basis of the primary band and the backup band of the port P.

In a step S15, the calculation unit 22 calculates a band of a link L on the basis of the band candidate of the port P and the topology information.

In a step S16, the output unit 23 outputs band information indicating the band of the link L to the band management device 3.

### <Functional Configuration of Band Management Device>

The band management device 3 is constituted by a computer. The band management device 3 receives input of the band information outputted by the output unit 23 of the band calculation device 2. The band management device 3 may store the band information or may display the band information on a display device such as a liquid crystal panel, an organic EL (electro luminescence). The band management device 3 may transmit the band information to another information processing device.

As described above, according to the first embodiment, the band calculation device 2 appropriately calculates the band of the link L connecting the nodes N in any of the relay networks NW_{R} in which the topology is different and the primary path and the backup path are different. Specifically, the band calculation device 2 can appropriately calculate the band of the link L, even if the topology of the relay network is a ring type as shown in the first example, or a mesh type as shown in the second example, by using the topology information, the path information, and the traffic information. Therefore, the band calculation device 2 can reduce man-hours required for processing for calculating the band of the link L constituting the relay network NW_{R}.

Further, according to the first embodiment, even when an arbitrary backup path is provided, a band expected to be necessary can be calculated based on the traffic statistic value in the primary path and the backup path, respectively. Therefore, the band calculation device 2 can reduce man-hours required for processing for calculating the band of the link L constituting the relay network NW_{R}.

Also, according to the first embodiment, when the backup path is not the minimum link cost but complicated, for example, in the example of the relay network NW_{R1} shown in FIG. 2, even when backup is set so as to sequentially pass through the node N₃, the node N₁, the node N₄, and the node N₂, an appropriate band of each of the nodes constituting appropriately the relay network NW_{R1} can be calculated on the basis of the path information indicating a communication port through which a backup path passes, and the traffic information indicating the traffic statistic value of each of the ports.

Note that, in the first embodiment described above, when a plurality of backup paths having a transmission side port of the primary path as a via transmission port are indicated in the path information, the calculation unit 22 calculates the backup band of the port P as the maximum value of the primary band of the primary path corresponding to each of the plurality of backup paths, but this is not limited thereto. For example, when path information indicates a plurality of backup paths having a transmission side port of a primary path as a via transmission port, the calculation unit 22 may calculate the backup band of the port P as the total value of the primary bands of the primary paths corresponding to each of the plurality of backup paths. In such a configuration, the calculation unit 22 extracts primary paths “path 1” and “path 2” corresponding to backup paths “path 1-1” and “path 2-2” using the port P₂ as a via transmission port. Then, the calculation unit 22 calculates the total of the primary bands “t_1” and “t_4” of the primary paths “path 1” and “path 2” as the backup band of the port P₂ (refer to FIG. 19). Accordingly, the calculation unit 22 calculates a band candidate of the port P₂ as “t_1+t_4” (refer to FIG. 20), and calculates a band of the link L₂ as “max (t_1+t_4, t_5+t_8)” (refer to FIG. 21).

In addition, the input unit 21 receives input of the guarantee level, and the calculation unit 22 may calculate one of the maximum value among primary bands of primary paths corresponding to the plurality of backup paths and the total of primary bands of primary paths corresponding to the plurality of backup paths as the backup band of the port P.

### Second Embodiment

The overall configuration of a second embodiment will be described with reference to FIG. 22. FIG. 22 is a schematic diagram of a band calculation system 101 according to a second embodiment. The same components as those in the first embodiment and the second embodiments are denoted by the same reference numerals and description thereof is omitted.

The band calculation system 101 according to the second embodiment calculates a band of a relay network NW_{R3} that relays information transmitted and received between nodes N included in each of n (n is an integer of 3 or more) user networks NW_{U}. In the example shown in FIG. 23, the three user networks NW_{UA}, NW_{UB}, and NW_{UC} communicate information with each other via the relay network NW_{R3}. The band calculation system 101 includes a network information management device 1-1, a band calculation device 2-1, and a band management device 3. Here, same functional units in the second embodiment as those of the first embodiment are denoted by same reference signs and descriptions thereof will be omitted.

The network information management device 1-1 includes a topology storage unit 11, a path storage unit 12, a traffic statistic storage unit 13, and an output unit 14.

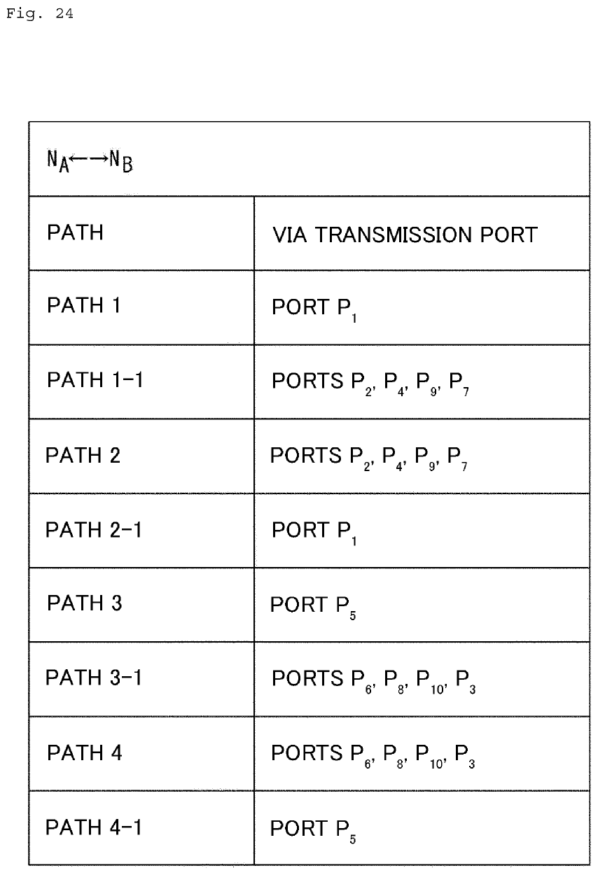

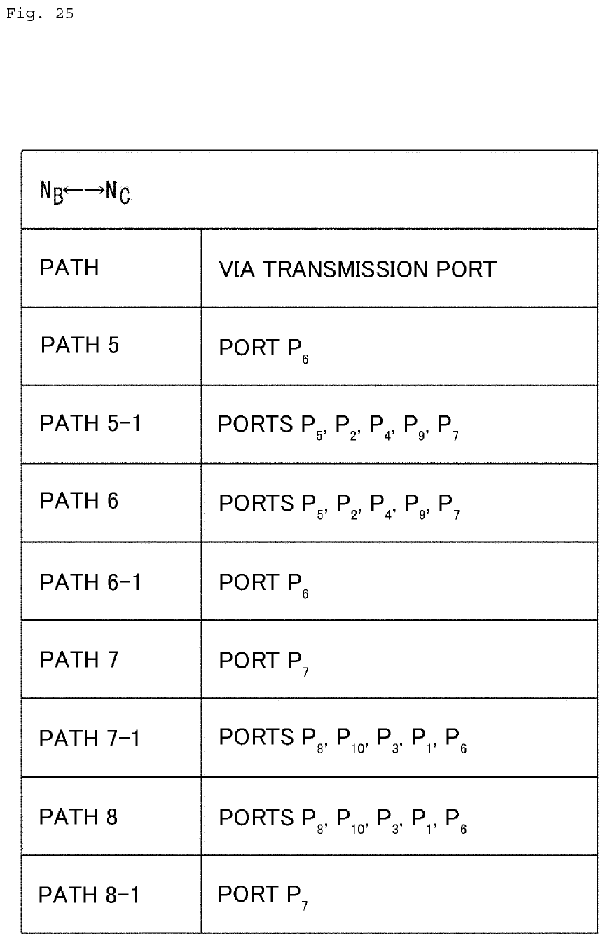

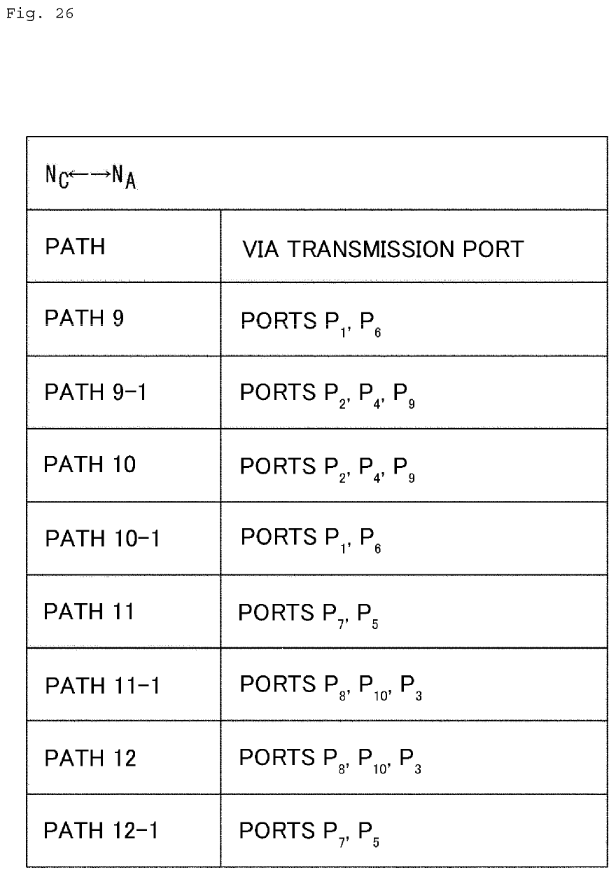

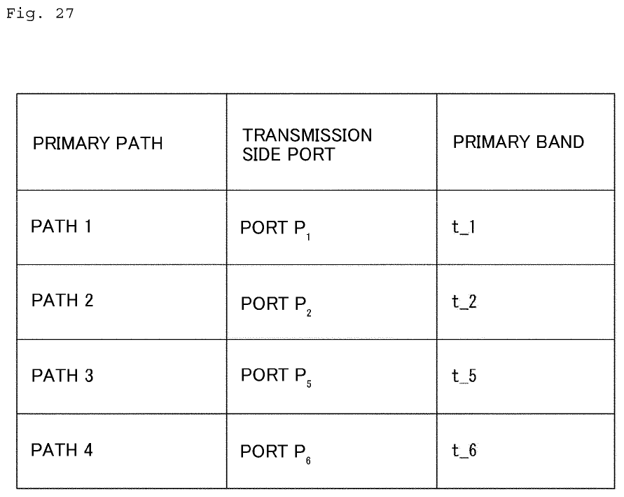

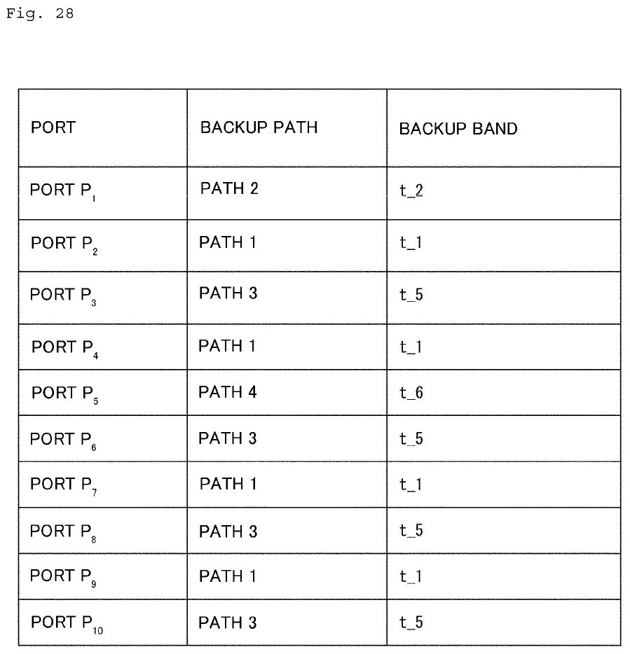

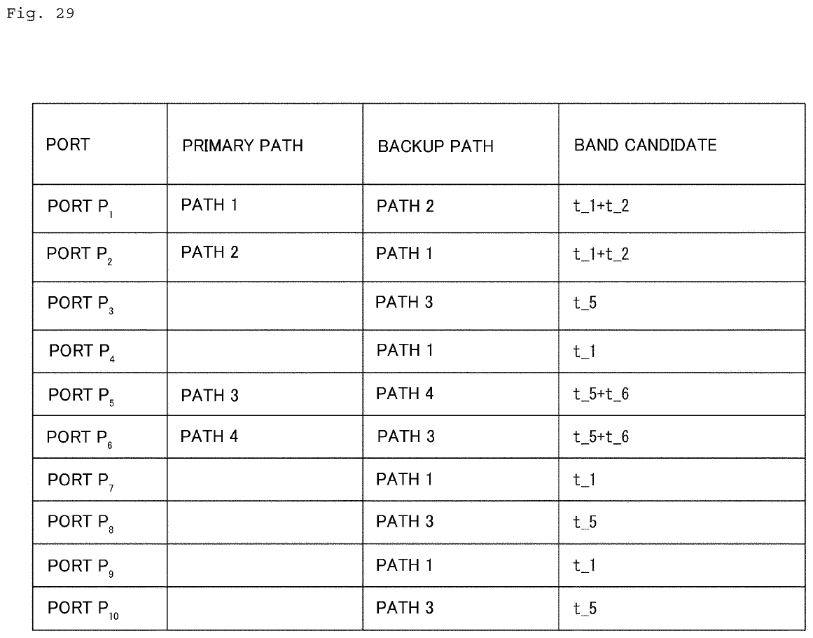

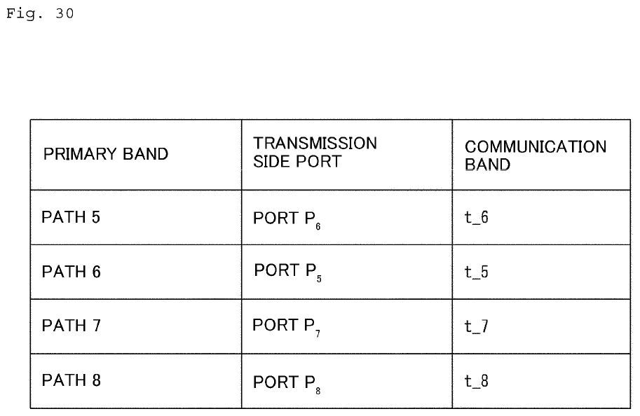

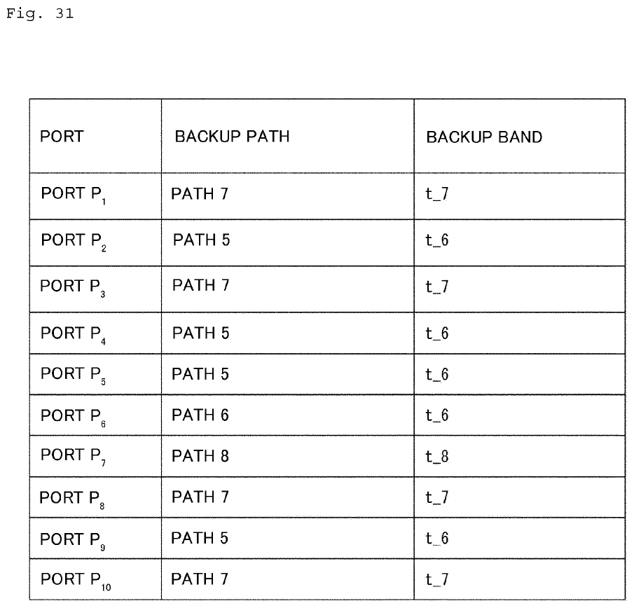

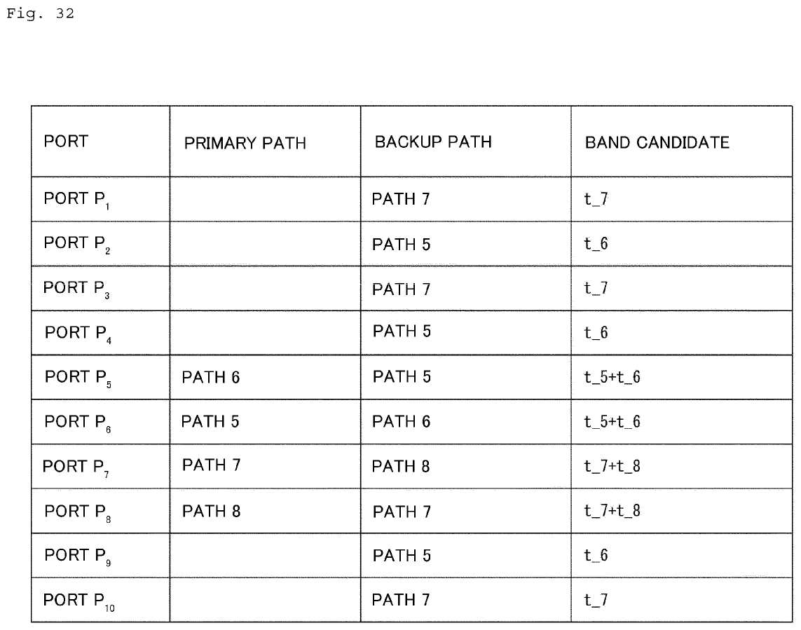

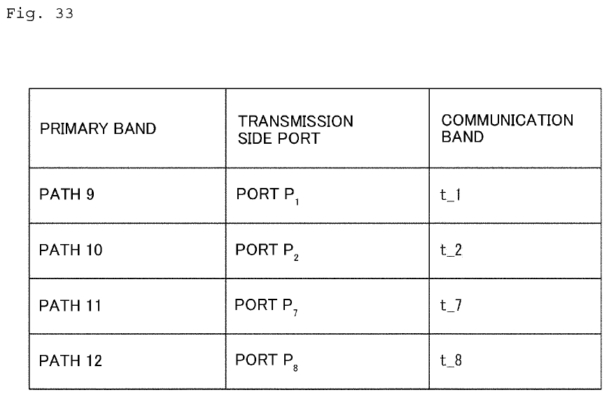

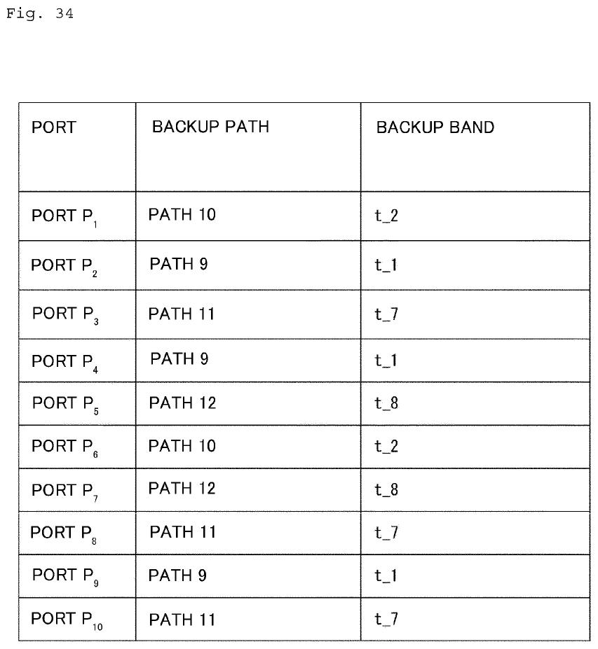

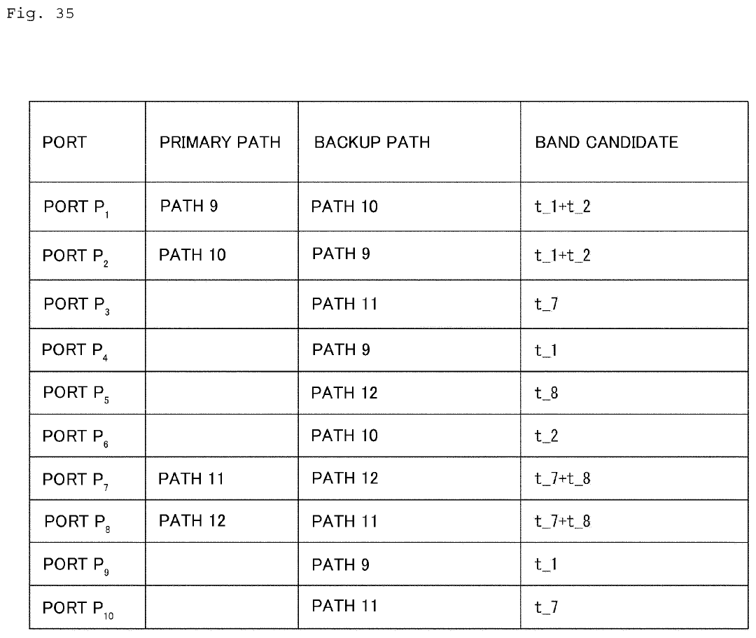

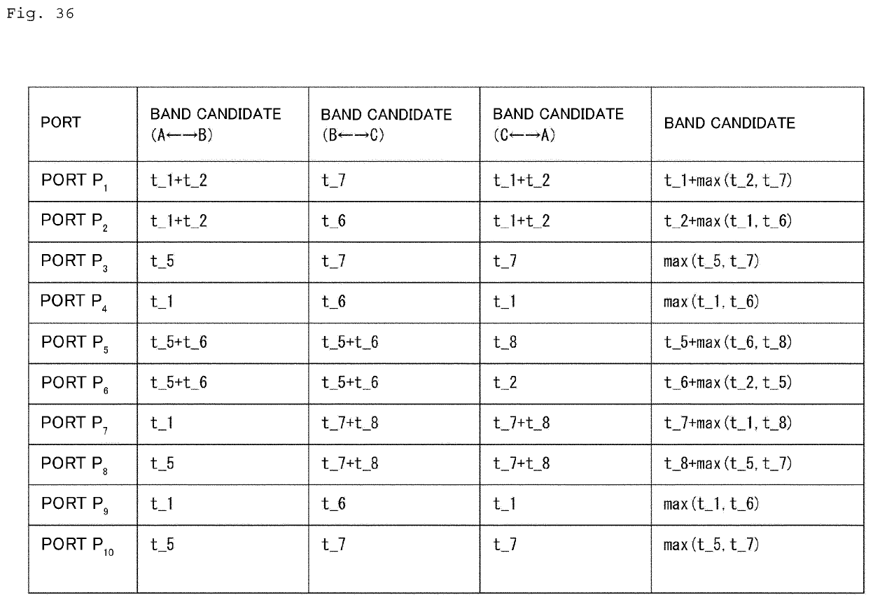

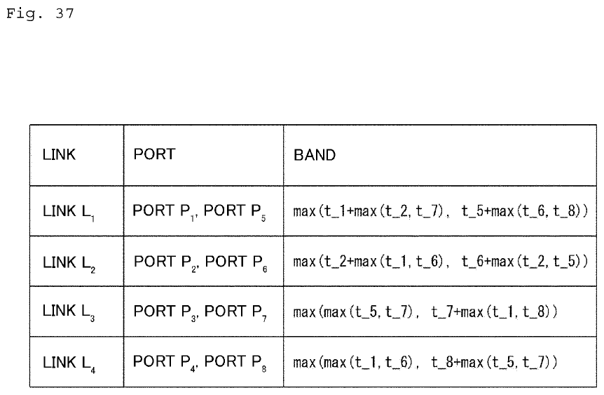

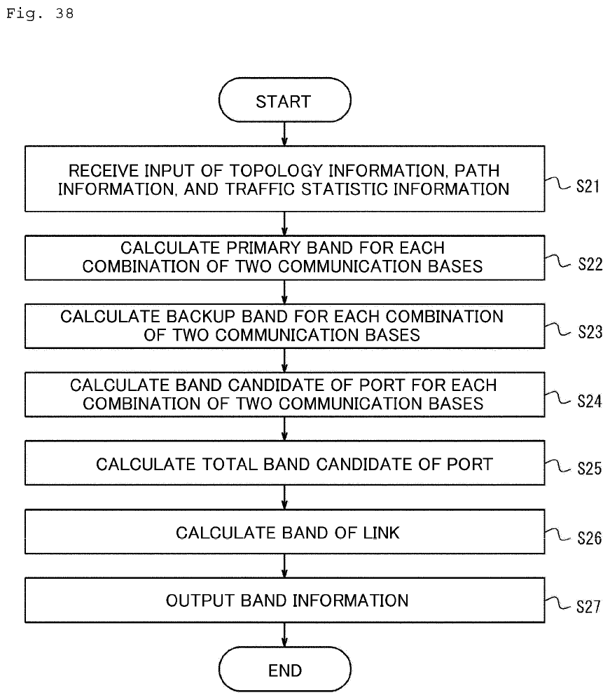

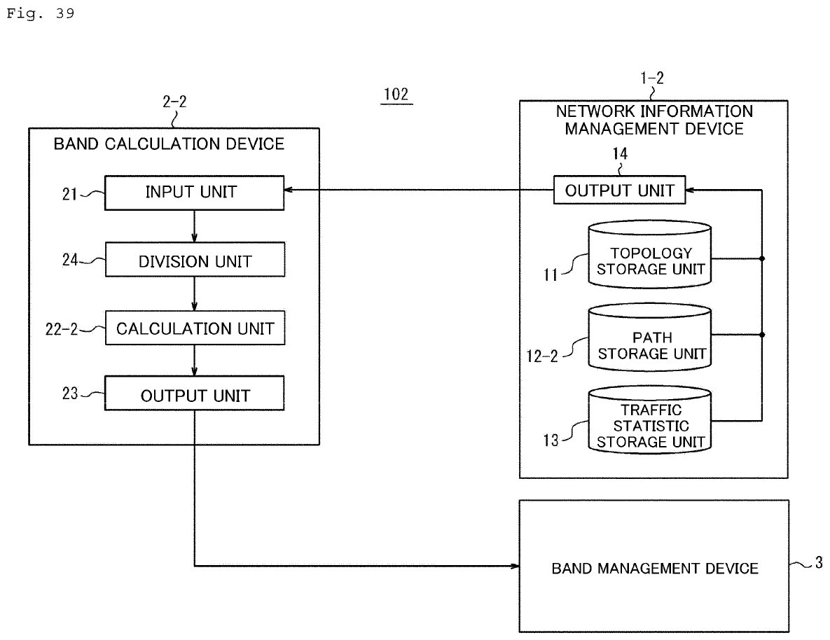

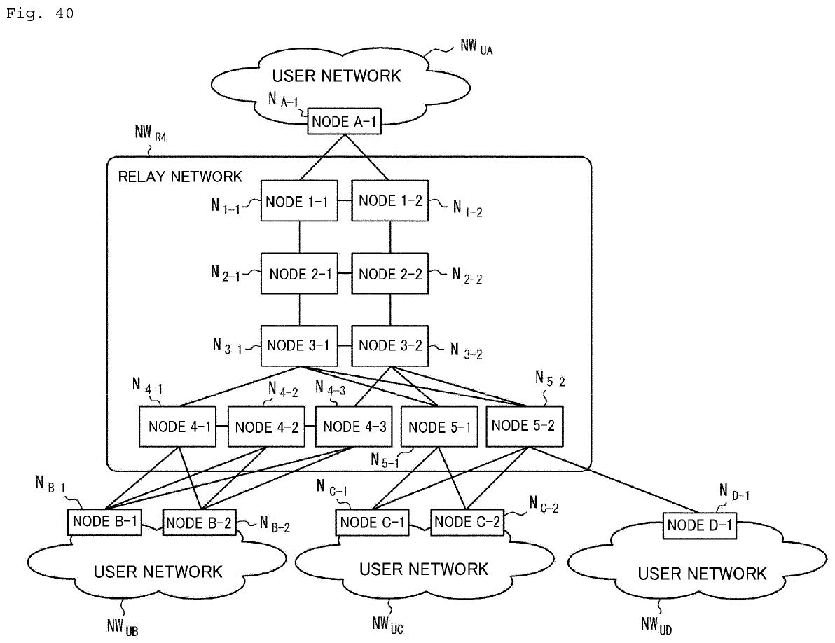

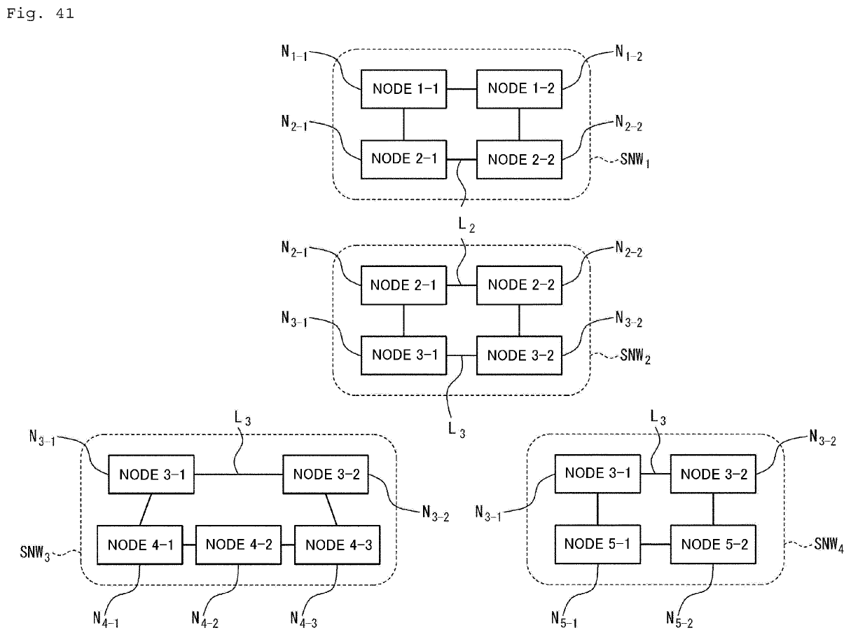

The path storage unit 12 stores path information on a path that is a transmission path when information is transmitted between one user network NW_{U} and another user network NW_{U}. The path storage unit 12 stores (n×(n−1))/2 pieces of path information for each combination of two user networks NW_{U} among all the user networks NW_{U}. In an example of the relay network NW_{R3} shown in FIG. 23, the path storage unit 12 stores path information in communication between the user network NW_{UA} and the user network NW_{UB} as shown in FIG. 24, path information in communication between the user network NW_{UB} and the user network NW_{UC} as shown in FIG. 25, and path information in communication between the user network NW_{UC} and the user network NW_{UA} as shown in FIG. 26.

### <Functional Configuration of Band Calculation Device>

Similarly to the band calculation device 2 of the first embodiment, the band calculation device 2-1 calculates the band of the link L of the relay network NWR₃ which is constituted by the node N and the link L connecting the ports P of the node N and which relays information transmitted and received between a plurality of communication bases.

As shown in FIG. 22, the band calculation device 2-1 includes an input unit 21, a calculation unit 22-1, and an output unit 23.

The calculation unit 22-1 calculates, on the basis of the topology information, the path information, and the traffic information whose input is received by the input unit 21, a band of a link L included in the relay network NW_{R3}. Specifically, when the relay network NW_{R} relays information transmitted and received between three or more communication bases, the calculation unit 22-1 calculates a band candidate of the port P for each transmission of information between the two communication bases on the basis of the path information of each combination of the two communication bases. Then, the calculation unit 22-1 calculates a total band candidate of the port P on the basis of the band candidate of the port P calculated for each transmission of information between two communication bases, and calculates a band of the link L on the basis of the total band candidate.

Hereinafter, the details are described by using an example, as shown in FIG. 23, in which the node N_{A} (first communication base), the node N_{B} (second communication base) and the node N_{C} (third communication base), which are respectively included in the three user networks NW_{UA}, N_{UB} and N_{UC}, communicate with each other via the relay network NW_{R3}.

The calculation unit 22-1 calculates a band candidate of each port when communication is performed between the first and second communication bases. In addition, the calculation unit 22-1 calculates a band candidate of each port when communication is performed between the second and third communication bases. Further, the calculation unit 22-1 calculates a band candidate of each port when communication is performed between the third and first communication bases. Then, the calculation unit 22-1 calculates the band of the link L on the basis of the band candidate of each port. The method of calculating the band candidate in the communication between the two user networks NW_{U} by the calculation unit 22-1 is the same as the method of calculating the band by the calculation unit 22 in the first embodiment.

Here, an example of the processing of the calculation unit 22-1 when the input of the path information shown in FIGS. 24 to 26 is received by the input unit 21 will be described. In the description of this example, the traffic information includes a traffic statistic value “t_9” of the port P₉ and a traffic statistic value “t_10” of the port P₁₀ in addition to the information shown in FIG. 5.

First, the calculation unit 22-1 calculates a band candidate of a port in communication between first and second communication bases. The processing for calculating the band candidates of each port in the communication between the first and second communication bases by the calculation unit 22-1 is the same as the processing for calculating the band candidates by the calculation unit 22 of the first embodiment.

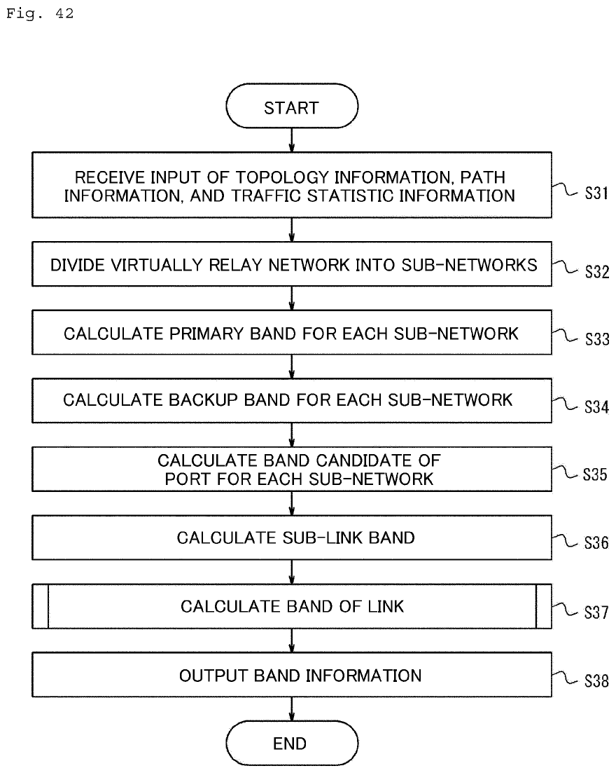

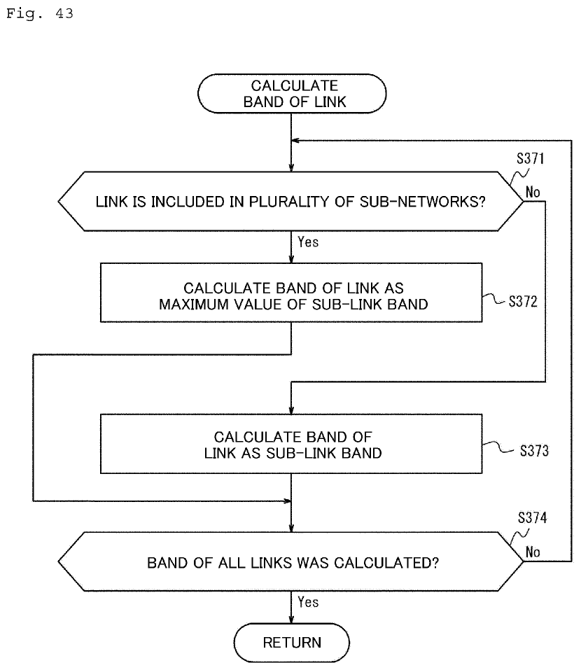

In this example, the calculation unit 22-1 calculates, from path information shown in FIG. 24, a primary band of a port P₁ which is a transmission side port of a primary path “path 1” as “t_1” which is a traffic statistic value corresponding to the port P₁ in the traffic information (refer to FIG. 27). In the same way, the calculation unit 22-1 calculates the primary band of each transmission side port of “path 2” to “path 4” which are primary paths.

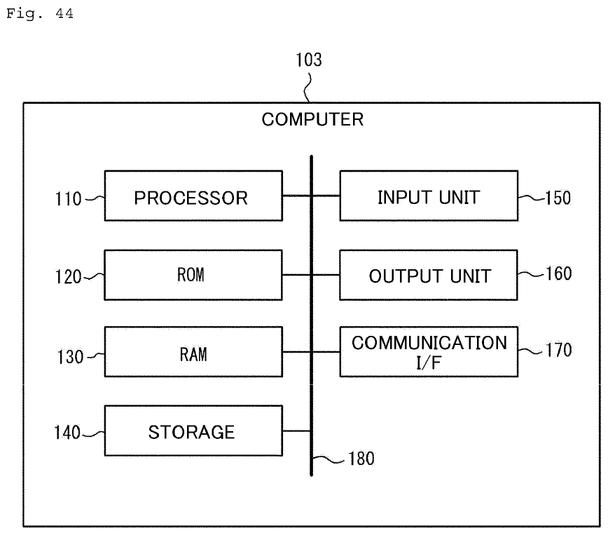

Then, the calculation unit 22-1 extracts a primary path “path 2” corresponding to a backup path “path 2-1” using the port P₁ as a via transmission port on the basis of the path information shown in FIG. 24. Then, the calculation unit 22-1 calculates a backup band of the port P₁ as a primary band “t_2” of the extracted “path 2” (refer to FIG. 28). Similarly, the calculation unit 22-1 calculates the backup bands of the ports of P₂ to P₈.

Then, the calculation unit 22-1 calculates the band candidate of the port P₁ as the sum “t_1+t_2” of the primary band “t_1” of the port P₁ shown in FIG. 27 and the backup band “t_2” of the port P₁ shown in FIG. 28 (refer to FIG. 29). Similarly, the calculation unit 22-1 calculates band candidates of each port of P₂ to P₈.

Next, the calculation unit 22-1 calculates a band candidate of the port P in communication between the second and third communication bases. The processing for calculating the band candidates of each port P in the communication between the second and third communication bases by the calculation unit 22-1 is the same as the processing for calculating the band candidates by the calculation unit 22 of the first embodiment.

In this example, the calculation unit 22-1 calculates the primary band of the port P₆, which is the transmission side port of the primary path “path 5”, from the path information shown in FIG. 25, as “t_6”, which is the traffic statistic value corresponding to the port P₆ in the traffic information (refer to FIG. 30). In the same way, the calculation unit 22-1 calculates the primary band of each transmission side port of “path 6” to “path 8” which are primary paths.

Then, the calculation unit 22-1 extracts a primary path “path 7” corresponding to “path 7-1” which is a backup path using the port P₁ as a via transmission port on the basis of the path information shown in FIG. 25. Then, the calculation unit 22-1 calculates a backup band of the port P₁ as a primary band “t_7” of the extracted “path 7” (refer to FIG. 31). Similarly, the calculation unit 22-1 calculates the backup bands of the ports of P₂ to P₁₀.

Then, the calculation unit 22-1 calculates the band candidate of the port P₅ as the sum “t_5+t_6” of the primary band “t_5” of the port P₅ shown in FIG. 30 and the backup band “t_6” of the port P₅ shown in FIG. 31 (refer to FIG. 32). Similarly, the calculation unit 22-1 calculates respective band candidates of the ports P₁ to P₄ and the ports of P₆ to P₈.

Subsequently the calculation unit 22-1 calculates a band candidate of each port in communication between the third and first communication bases. The processing for calculating the band candidates of each port in the communication between the third and first communication bases by the calculation unit 22-1 is the same as the processing for calculating the band candidates by the calculation unit 22 of the first embodiment.

In this example, the calculation unit 22-1 determines a primary band of a port P₁ which is a transmission side port of a primary path “path 9” from the path information shown in FIG. 26 as “t_1” which is a traffic statistic value corresponding to the port P₁ in the traffic information (refer to FIG. 33). In the same way, the calculation unit 22-1 calculates the primary band of each transmission side port of “path 10” to “path 12” which are primary paths.

Then, the calculation unit 22-1 extracts a “path 10” which is a primary path corresponding to a “path 10-1” which is a backup path using the port P₁ as a via transmission port on the basis of the path information shown in FIG. 26. Then, the calculation unit 22-1 calculates a backup band of the port P₁ as “t_2” which is a primary band of the extracted “path 10” (refer to FIG. 34). In the same way, the calculation unit 22-1 calculates the backup bands of each port of P₂ to P₁₀.

Then, the calculation unit 22-1 calculates the band candidate of the port P₁ as the sum “t_1+t_2” of the primary band “t_1” of the port P₁ shown in FIG. 33 and the backup band “t_2” of the port P₁ shown in FIG. 34 (refer to FIG. 35). In the same way, the calculation unit 22-1 calculates respective band candidates of the ports of P₂ to P₁₀.

Then, the calculation unit 22-1 calculates the band of the link L on the basis of the topology information and the band candidates of the port P in each combination of the two user networks NW_{U}.

First, the calculation unit 22-1 calculates a total band candidate of the port P on the basis of the band candidate of the port P. Specifically, the calculation unit 22-1 calculates the total of the primary band included in the band candidate of the port P in the band candidate in each combination of the two user networks NW_{U} and the maximum value of the backup band as a total band candidate. In this example, as shown in FIG. 29, the bandwidth candidate of the port P₁ in communication between the first and second communication bases is “t_1+t_2”. As shown in FIG. 32, the band candidate of the port P₁ in communication between the second and third communication bases is “t_7”. As shown in FIG. 35, the band candidate of the port P₁ in communication between the third and first communication bases is “t_1+t_2”. Therefore, the calculation unit 22-1 sets the total “t_1+max (t_2, t_7)” of the primary band “t_1” included in these band candidates and the maximum value “max (t_2, t_7)” of the backup band as a total band candidate. In the same way, the calculation unit 22-1 calculates the total band candidates of each port of P₂ to P₁₀ (refer to FIG. 36).

Then, the calculation unit 22-1 calculates the band of the link L on the basis of the total band candidate of the port P and the topology information. Specifically, the calculation unit 22 extracts two ports P to be connected to each other by each of the links L on the basis of the topology information, and sets the band of the link L to the band candidate that is the larger one of the total band candidates of the two ports P. In this example, as shown in FIG. 37, the calculation unit 22-1 extracts a port P₁ and a port P₅ to which the link L₁ is connected to each other, and calculates the band of the link L₁ as “max (t_1+max (t_2, t_7), t_5+max (t_6, t_8)” which is a larger band candidate of the port P₁ and the port P₅. In the same way, the calculation unit 22-1 calculates respective bands of a link L₁ to a link L₄.

### <Operation of Band Calculation Device>

Here, an operation of the band calculation device 2 according to the second embodiment will be described with reference to FIG. 38. FIG. 38 is a flow chart showing an example of the operation of the band calculation device 2 according to the second embodiment. The operation of the band calculation device 2, which will be described with reference to FIG. 38, corresponds to a band calculation method of the band calculation device 2 according to the second embodiment.

In a step S21, the input unit 21 receives the input of the topology information, the path information, and the traffic information from the network information management device 1.

In a step S22, the calculation unit 22-1 determines a primary band of a transmission side port of a primary path for each combination of two communication bases on the basis of the path information and the traffic information.

In a step S23, the calculation unit 22-1 calculates a backup band of the port P for each combination of two communication bases on the basis of the path information and the traffic information.

In a step S24, the calculation unit 22-1 calculates a band candidate of the port P on the basis of the primary band and the backup band of the port P for each combination of the two communication bases.

In a step S25, the calculation unit 22-1 calculates a total band candidate of the port P on the basis of the band candidate of the port P for each combination of the two communication bases.

In a step S26, the calculation unit 22-1 calculates the band of the link L on the basis of the total band candidate of the port P and the topology information.

In a step S27, the output unit 23 outputs band information indicating the band of the link L to the band management device 3.

As described above, according to the second embodiment, when the relay network NW_{R3} relays communication between three or more communication bases, the total band candidate is calculated on the basis of the maximum value of the backup band included in the band candidate, and the band of the link L is calculated on the basis of the total band candidate. If the total band candidate is calculated on the basis of the total of the backup bands, for example, the backup band in communication from the second communication base to the first communication base and the backup band in communication from the third communication base to the first communication base may be superimposed and summed. Thus, there is a problem that a band which becomes an overspecification with respect to a required traffic volume is designed. On the other hand, since the band calculation device 2-1 of the second embodiment calculates the total band candidate on the basis of not the total of the backup bands but the maximum value of the backup bands, the band can be appropriately calculated without calculating a backup band on which traffic volumes from two different communication bases are superimposed.

Thus, according to the second embodiment, the band calculation device 2 can reduce the man-hours required for calculating the band of the link L constituting the relay network NW_{R3}. In particular, in a large-scale relay network NW_{R3} which relays communication between three or more user networks, for example, and which is constituted by several hundreds to several thousands of nodes N, it is expected that an increase in man-hours required for processing for calculating the band of the link L is remarkable, and in such a case, the man-hours can be reduced especially largely.

Note that, in the second embodiment, the calculation unit 22-1 may determine whether there are three or more communication bases. In such a configuration, when it is judged that there are two user networks NW, the calculation unit 22-1 may perform processing similar to that of the calculation unit 22 of the first embodiment, and when it is judged that there are three or more communication bases, the calculation unit 22-1 may perform the processing described in the second embodiment.

In addition, although the second embodiment has been described with reference to an example in which there are three communication bases, there may be four or more communication bases.

### Third Embodiment

The overall configuration of a third embodiment will be described with reference to FIG. 39. FIG. 39 is a schematic diagram of a band calculation system 102 according to a third embodiment. In the band calculation system 102 according to the third embodiment, nodes included in four user networks transmit and receive information to and from each other via a relay network as shown in FIG. 40.

In the example shown in FIG. 40, the four user networks NW_{UA}, NW_{UB}, NW_{UC}, and NW_{UD} communicate information with each other via the relay network NW_{R3}. The relay network NW_{R3} includes a node N₁₋₁, a node N₁₋₂, a node N₂₋₁, a node N₂₋₂, a node N₃₋₁, a node N₃₋₂, a node N₄₋₁, a node N₄₋₂, a node N₄₋₃, a node N₅₋₁ and a node N₅₋₂. The nodes N₁₋₁ and N₁₋₂, the nodes N₂₋₁ and N₂₋₂, the nodes N₃₋₁ and N₃₋₂, the nodes N₅₋₁ and N₅₋₂ are configured to be redundant with each other. The nodes N₄₋₁, N₄₋₂, and N₄₋₃ are configured to be redundant with each other.

### <Functional Configuration of Band Calculation Device>

Similarly to the band calculation device 2 of the first embodiment, the band calculation device 2-2 calculates a band of a link L of a relay network which is constituted by a node N and a link L connecting ports P of the node N and which relays information transmitted and received between a plurality of communication bases.

As shown in FIG. 39, the band calculation device 2-2 includes an input unit 21, a calculation unit 22-2, an output unit 23, and a division unit 24.

The division unit 24 virtually divides the relay network NW_{R4} into sub-groups SNW on the basis of the topology information and the path information. The sub-network SNW is a sub-network including a node group having a plurality of nodes configured redundantly with each other, and another node group having a plurality of nodes directly connected from the nodes included in the node group and configured redundantly with each other.

In an example of the relay network NW_{R4} shown in FIG. 40, the division unit 24 virtually divides, as shown in FIG. 41, the relay network NW_{R4} into sub-networks SNW₁, SNW₂, SNW₃, and SNW₄. The sub-network SNW₁ includes a node group G1 having nodes N₁₋₁ and N₁₋₂ which are redundantly configured with each other, and a node group G2 having nodes N₂₋₁ and N₂₋₂ which are directly connected from the nodes N₁₋₁ and N₁₋₂ included in the node group G1 and are redundantly configured with each other. The sub-network SNW₂ includes a node group G2 having nodes N₂₋₁ and N₂₋₂ which are redundantly configured with each other, and a node group G3 having nodes N₃₋₁ and N₃₋₂ which are directly connected from the nodes N₂₋₁ and N₂₋₂ included in the node group G2 and are redundantly configured with each other. The sub-network SNW₃ includes a node group G3 having nodes N₃₋₁ and N₃₋₂ which are redundantly configured with each other, and a node group G4 having nodes N₄₋₁ and N₄₋₂ which are directly connected from the nodes N₃₋₁ and N₃₋₂ included in the node group G3 and are redundantly configured with each other, and a node N₄₋₃. The sub-network SNW₄ includes a node group G3 having nodes N₃₋₁ and N₃₋₂ which are redundantly configured with each other, and a node group G5 having nodes N₅₋₁ and N₅₋₂ which are directly connected from the nodes N₃₋₁ and N₃₋₂ included in the node group G3 and are redundantly configured with each other.

The calculation unit 22-2 calculates a sub-link band which is a band of a link L for each sub-network SNW, and calculates a band of the link L of the relay network NW_{R4} on the basis of the sub-link band. Thereafter, the processing of the calculation unit 22-2 will be described in detail.

First, the calculation unit 22-2 calculates a primary band for each sub-network SNW. The method of calculating the primary band by the calculation unit 22-2 is the same as the method of calculating the primary band by the calculation unit 22 of the first embodiment. In addition, the calculation unit 22-2 calculates a backup band for each sub-network SNW. The method of calculating the primary band by the calculation unit 22-2 is the same as the method of calculating the backup band by the calculation unit 22 of the first embodiment. In addition, the calculation unit 22-2 calculates a band candidate of a port P for each sub-network SNW. The method of calculating the bandwidth candidate of the port P by the calculation unit 22-2 is the same as the method of calculating the band candidate of the port P by the calculation unit 22 of the first embodiment. In addition, the calculation unit 22-2 calculates a sub link band which is a band of a link for each sub network SNW. The method of calculating the sub-link band which is the band of the link for each sub-network SNW by the calculation unit 22-2 is the same as the method of calculating the band of the link by the calculation unit 22 of the first embodiment.

Further, the calculation unit 22-2 calculates the band of the link L on the basis of the sub-link band.

Specifically, the calculation unit 22-2 first judges whether or not the link L is included in a plurality of sub-networks SNW. When it is judged that the link L is included in the plurality of sub-networks SNW, the calculation unit 22-2 calculates the band of the link L as the maximum value of the sub-link band of the plurality of sub-networks SNW including the link L. When it is judged that the link L is included in one sub-network SNW, the calculation unit 22-2 calculates the band of the link L as the sub-link band of the sub-network SNW including the link L.

### <Operation of Band Calculation Device>

Here, an operation of the band calculation device 2-2 according to the third embodiment will be described with reference to FIG. 42. FIG. 42 is a flow chart showing an example of the operation of the band calculation device 2-2 according to the third embodiment. The operation of the band calculation device 2-2 which will be described with reference to FIG. 42 corresponds to a band calculation method of the band calculation device 2-2 according to the third embodiment.

In a step S31, the input unit 21 receives the topology information, the path information, and the traffic information from the network information management device 1.

In a step S32, the division unit 24 virtually divides the relay network NW_{R4} into sub-groups SNW on the basis of the topology information and the path information.

In a step S32, the calculation unit 22-2 determines a primary band of a port P which is a transmission side port of a primary path, for each sub-group SNW, on the basis of the path information and the traffic information.

In a step S33, the calculation unit 22-2 calculates a backup band of the port P for each sub-group SNW on the basis of the path information and the traffic information.

In a step S35, the calculation unit 22-2 calculates a band candidate of the port P for each sub-group SNW on the basis of a primary band and a backup band of the port P.

In a step S36, the calculation unit 22-2 calculates a sub-link band which is a band of a link L for each sub group SNW on the basis of the band candidate of the port P and the topology information.

In a step S37, the calculation unit 22-2 calculates a band of a link L in the relay network NW_{R4} on the basis of the sub-link band.

Here, the operation of calculating the link L in the relay network NW_{R4} based on the sub-link band by the calculation unit 22-2 will be described with reference to FIG. 43.

In a step S371, the calculation unit 22-2 judges whether or not the link L is included in a plurality of sub-networks SNW.

When it is judged that the link L is included in the plurality of sub-networks SNW in the step S371, the calculation unit 22-2 calculates the band of the link L as the maximum value of the sub-link band of the plurality of sub-networks SNW including the link L in a step S372.

When it is judged that the link L is included in one sub-network SNW in the step S371, the calculation unit 22-2 calculates a band of the link L as a sub-link band of the sub-network SNW including the link L in a step S373.

In a step S374, the calculation unit 22-2 judges whether or not the bands of all the links have been calculated.

When it is judged that there is a link L whose band is not calculated in the step S374, the calculation unit 22-2 returns to the step S371 and repeats the processing. When it is judged that the bands of all the links are calculated in the step S374, the calculation unit 22-2 terminates processing for calculating the bands of the links L.

Returning to FIG. 42, in a step S38, the output unit 23 transmits band information indicating the band of the link L to the band management device 3.

As described above, according to the third embodiment, the band calculation device 2-2 further includes the division unit 24 for virtually dividing the relay network NW_{R4} into sub-networks SNW. Then, the calculation unit 22 of the band calculation device 2-2 calculates a sub-link band which is a band of a link L for each sub-network SNW, and calculates the band of the link L on the basis of the sub-link bands. Therefore, the band calculation device 2-2 can calculate the band of the link L with a smaller calculation amount compared to the case where the band of the link L is calculated similarly to the first embodiment without virtually dividing the relay network NW_{R4} into the sub-networks SNW. Thus, the processing load of the band calculation device 2-2 is reduced.

### <<Program>>

It is also possible to use a computer 103 capable of executing program commands to function as each of the band calculation devices 2, 2-1, and 2-2 described above. FIG. 44 is a block diagram showing a schematic configuration of the computer 103 that functions as each of the band calculation devices 2, 2-1, and 2-2. Here, the computer 103 may be a general-purpose computer, a dedicated computer, a work station, a personal computer (PC), an electronic notepad, or the like. The program command may be a program code, a code segment, or the like for executing the necessary task. Similarly, the computer 103 capable of executing program commands can be used to function as the band calculation devices 2, 2-1, and 2-2.

### <<Hardware Configuration>>

As shown in FIG. 44, the computer 103 includes a processor 110, a read only memory (ROM) 120, a random access memory (RAM) 130, a storage 140, an input unit 150, an output unit 160, and a communication interface (I/F) 170. Each of the configurations is communicatively connected via a bus 180. The processor 110 is specifically a central processing unit (CPU), a micro processing unit (MPU), a graphics processing unit (GPU), a digital signal processor (DSP), a system on a chip (SoC), or the like and may be composed of multiple processors of the same type or different types.

The processor 110 controls each component and executes various kinds of arithmetic processing. That is to say, the processor 110 reads a program from the ROM 120 or the storage 140 and executes the program using the RAM 130 as a work region. The processor 110 performs control of each of the above components and various arithmetic processing in accordance with programs stored in the ROM 120 or the storage 140. In the embodiment, the ROM 120 or the storage 140 stores a program according to the present disclosure.

The program may be recorded on a recording medium that can be read by the computer 103. If such a recording medium is used, the program can be installed in the computer 103. Here, the recording medium on which the program is recorded may be a non-transitory recording medium. The non-transitory recording medium is not particularly limited, but may be, for example, a CD-ROM, a DVD-ROM, a universal serial bus (USB) memory, or the like. Also, this program may be downloaded from an external device over a network.

The ROM 120 stores various programs and various data. The RAM 130 temporarily stores programs or data as a work region. The storage 140 is configured by a hard disk drive (HDD) or a solid state drive (SSD) and stores various programs, including an operating system, and various types of data.

The input unit 150 includes one or more input interfaces through which user's input operations are received and information based on the user's operations is acquired. For example, the input unit 150 is a pointing device, a keyboard, a mouse, and the like, but is not limited to these.

The output unit 160 includes one or more output interfaces through which information is outputted. For example, the output unit 160 is a display for outputting information as a video or a speaker for outputting information as a sound, but is not limited thereto.

The communication interface 170 is an interface for communicating with other equipment such as an external device, and, for example, standards such as Ethernet (registered trademark), FDDI, or Wi-Fi (registered trademark) are used.

All documents, patent applications, and technical standards mentioned in this specification are incorporated herein by reference to the same extent as if each individual document, patent application, or technical standard were specifically and individually indicated to be incorporated by reference.

While one embodiment has been described above as a typical example, it is clear for a person skilled in the art that many alterations and substitutions are possible without departing from the subject matter and scope of the present disclosure. Therefore, the embodiment described above should not be interpreted as limiting, and the present invention can be modified and altered in various ways without departing from the scope of the claims. For example, a plurality of configuration blocks shown in the configuration diagram of the embodiment may be combined to one, or one configuration block may be divided.

### REFERENCE SIGNS LIST

1, 1-1, 1-2 Network information management device
2, 2-1, 2-2 Band calculation device
3 Band management device
11 Topology storage unit
12, 12-1, 12-2 Path storage unit
13 Traffic statistic storage unit
14 Output unit
21 Input unit
22, 22-1, 22-2 Calculation unit
23 Output unit
24 Division unit
100, 101, 102 Band calculation system
103 Computer
110 Processor
120 ROM
130 RAM
140 Storage
150 Input unit
160 Output unit
170 Communication interface (I/F)
180 Bus

1. A band calculation device comprising a processor configured to execute operations comprising:
receiving an input of topology information associated with a relay network, path information associated with the relay network, and traffic information associated with the relay network,
wherein the relay network includes the nodes and the links, the links connect the nodes, the relay network relays data transmitted and received between a plurality of communication bases,
the topology information indicates ports of nodes as a part of a relay network, connection destination ports of the ports, and links connecting the ports, and the connection destination ports,
the path information indicates primary paths that relay the data when a failure does not occur, paths including backup paths that relay the data when the failure occurs in the primary path, and via transmission ports that are the ports for transmitting the data in the paths, and,
the traffic information indicates the port and traffic statistic value of the port, respectively; and
calculating a band of a link of the relay network on the basis of the topology information, the path information, and the traffic information.

2. The band calculation device according to claim 1, wherein
the calculating further comprises:
calculating a primary band that is a traffic volume of information transmitted by the via transmission port of the primary path when the failure does not occur based on the path information and the traffic information,
calculating a backup band that is a traffic volume of information transmitted by the via transmission port of a backup path having a transmission side port of the primary path as a via transmission port when the failure occurs, and
calculating a band of the link based on the primary band and the backup band.

3. The band calculation device according to claim 2, wherein
when the path information indicates a plurality of backup paths having a transmission side port of the primary path as a via transmission port, the calculating further comprises calculating a maximum value of the primary band of the primary path corresponding to each of the plurality of backup paths as the backup band.

4. The band calculation device according to claim 2, wherein
when the path information indicates the plurality of backup paths having the transmission side port of the primary path as the via transmission port, the calculating further comprises calculating a total value of the primary bands of the primary paths corresponding to each of the plurality of backup paths as the backup band.

5. The band calculation device according to claim 1, wherein
when the relay network relays data transmitted and received between three or more communication bases, the calculating further comprises:
calculating a band candidate of the port for each transmission of the data between the two communication bases on the basis of the path information of each combination of two communication bases,
calculating a total band candidate of the port on the basis of a band candidate of the port calculated for each transmission of the data between the two communication bases, and
calculating a band of the link on the basis of the total band candidate.

6. The band calculation device according to claim 1, the processor further configured to execute operations comprising:
dividing virtually the relay network into sub-networks, wherein each subnetwork includes a node group having a plurality of nodes configured redundantly with each other and another node group having a plurality of nodes directly connected from the nodes included in the node group and configured redundantly with each other, wherein
the calculating further comprises:
calculating a sub-link band that is a band of the link for each of the sub-networks, and
calculating a band of the link of the relay network on the basis of the sub-link bands.

7. A method for calculating a band, comprising:
receiving an input of topology information associated with a relay network, path information associated with the relay network, and traffic information associated with the relay network,
wherein the relay network includes the nodes and the links, the links connect the nodes, the relay network relays data transmitted and received between a plurality of communication bases,
the topology information indicates ports of nodes as a part of a relay network, connection destination ports of the ports, and links connecting the ports and the connection destination ports,
the path information indicates primary paths that relay the data when a failure does not occur, paths including backup paths that relay the data when the failure occurs in the primary path, and via transmission ports that are the ports for transmitting the data in the paths, and
the traffic information indicates the port and traffic statistic value of the port; and
calculating a band of a link of the relay network on the basis of the topology information, the path information and the traffic information.

8. A computer-readable non-transitory recording medium storing computer-executable program instructions that when executed by a processor cause a computer system to execute operations comprising:
receiving an input of topology information associated with a relay network, path information associated with the relay network, and traffic information associated with the relay network,
wherein the relay network includes the nodes and the links, the links connect the nodes, the relay network relays data transmitted and received between a plurality of communication bases,
the topology information indicates ports of nodes as a part of a relay network, connection destination ports of the ports, and links connecting the ports and the connection destination ports,
the path information indicates primary paths that relay the data when a failure does not occur, paths including backup paths that relay the data when the failure occurs in the primary path, and via transmission ports that are the ports for transmitting the data in the paths, and
the traffic information indicates the port and traffic statistic value of the port; and
calculating a band of a link of the relay network on the basis of the topology information, the path information and the traffic information.

9. The band calculation device according to claim 2, wherein
when the relay network relays data transmitted and received between three or more communication bases, the calculating further comprises:
calculating a band candidate of the port for each transmission of the data between the two communication bases on the basis of the path information of each combination of two communication bases,
calculating a total band candidate of the port on the basis of a band candidate of the port calculated for each transmission of the data between the two communication bases, and
calculating a band of the link on the basis of the total band candidate.

10. The band calculation device according to claim 2, the processor further configured to execute operations comprising:
dividing virtually the relay network into sub-networks, wherein each subnetwork includes a node group having a plurality of nodes configured redundantly with each other and another node group having a plurality of nodes directly connected from the nodes included in the node group and configured redundantly with each other, wherein
the calculating further comprises:
calculating a sub-link band that is a band of the link for each of the sub-networks, and
calculating a band of the link of the relay network on the basis of the sub-link bands.

11. The band calculation device according to claim 3, wherein
when the relay network relays data transmitted and received between three or more communication bases, the calculating further comprises:
calculating a band candidate of the port for each transmission of the data between the two communication bases on the basis of the path information of each combination of two communication bases,
calculating a total band candidate of the port on the basis of a band candidate of the port calculated for each transmission of the data between the two communication bases, and
calculating a band of the link on the basis of the total band candidate.

12. The band calculation device according to claim 3, further comprising:
dividing virtually the relay network into sub-networks, wherein each subnetwork includes a node group having a plurality of nodes configured redundantly with each other and another node group having a plurality of nodes directly connected from the nodes included in the node group and configured redundantly with each other, wherein
the calculating further comprises:
calculating a sub-link band that is a band of the link for each of the sub-networks, and
calculating a band of the link of the relay network on the basis of the sub-link bands.

13. The method according to claim 7, wherein
the calculating further comprises:
calculating a primary band that is a traffic volume of information transmitted by the via transmission port of the primary path when the failure does not occur based on the path information and the traffic information,
calculating a backup band that is a traffic volume of information transmitted by the via transmission port of a backup path having a transmission side port of the primary path as a via transmission port when the failure occurs, and
calculating a band of the link based on the primary band and the backup band.

14. The method according to claim 13, wherein
when the path information indicates a plurality of backup paths having a transmission side port of the primary path as a via transmission port, the calculating further comprises calculating a maximum value of the primary band of the primary path corresponding to each of the plurality of backup paths as the backup band.

15. The method according to claim 13, wherein
when the path information indicates the plurality of backup paths having the transmission side port of the primary path as the via transmission port, the calculating further comprises calculating a total value of the primary bands of the primary paths corresponding to each of the plurality of backup paths as the backup band.

16. The method according to claim 7, wherein
when the relay network relays data transmitted and received between three or more communication bases, the calculating further comprises:
calculating a band candidate of the port for each transmission of the data between the two communication bases on the basis of the path information of each combination of two communication bases,
calculating a total band candidate of the port on the basis of a band candidate of the port calculated for each transmission of the data between the two communication bases, and
calculating a band of the link on the basis of the total band candidate.

17. The method according to claim 7, further comprising:
dividing virtually the relay network into sub-networks, wherein each subnetwork includes a node group having a plurality of nodes configured redundantly with each other and another node group having a plurality of nodes directly connected from the nodes included in the node group and configured redundantly with each other, wherein
the calculating further comprises:
calculating a sub-link band that is a band of the link for each of the sub-networks, and
calculating a band of the link of the relay network on the basis of the sub-link bands.

18. The computer-readable non-transitory recording medium according to claim 8, wherein
the calculating further comprises:
calculating a primary band that is a traffic volume of data transmitted by the via transmission port of the primary path when the failure does not occur based on the path information and the traffic information,
calculating a backup band that is a traffic volume of data transmitted by the via transmission port of a backup path having a transmission side port of the primary path as a via transmission port when the failure occurs, and
calculating a band of the link based on the primary band and the backup band.

19. The computer-readable non-transitory recording medium according to claim 18,
wherein
when the path information indicates a plurality of backup paths having a transmission side port of the primary path as a via transmission port, the calculating further comprises calculating a maximum value of the primary band of the primary path corresponding to each of the plurality of backup paths as the backup band.

20. The computer-readable non-transitory recording medium according to claim 18, wherein
when the path information indicates the plurality of backup paths having the transmission side port of the primary path as the via transmission port, the calculating further comprises calculating a total value of the primary bands of the primary paths corresponding to each of the plurality of backup paths as the backup band.
